(19) United States
(12) Patent Application Publication
(10) Pub. No.: US 2014/0365633 A1
(43) Pub. Date: Dec. 11, 2014

(54) Networked integrated communications

(71) Applicant: Sivatharan Natkunanathan, Irvine, CA (US)

(72) Inventor: Sivatharan Natkunanathan, Irvine, CA (US)

(21) Appl. No.: 13/815,943

(22) Filed: Mar. 18, 2013

(51) Int. Cl. H04L 12/26

(52) U.S. Cl. CPC H04L 43/08
USPC 709/224

(57) ABSTRACT

The invention presents an enhanced and/or new system, process, procedure, product, product-by-process, and/or service, comprising a hardware, service software, and/or software service, comprising a website and/or webpage, for performance displaying during communication (“PDDC”), of, (1) ‘moving picture’, transmitted with means comprising data packets, by means of an online and/or computer network; and/or (2) “image content” comprising of ‘moving picture’, image, and/or associated audio if any, transmitted with means comprising data packets, by means comprising a phone and/or hybrid network.

Another segment of this invention presents an enhanced and/or new ‘internet-phone’, for a one, two, and/or multi-way, user-initiated call request-acceptance PDDC of IC bm_of_a_ntwk. A further segment of this invention is an enhanced and/or new wireless handheld computer, wireline phone, wireless handheld, and/or mobile phone, for PDDC of IC bm_comprising a_ntwk. A further segment of this invention is an enhanced and/or new Converged Platform, comprising with means of a user-account and/or an internet user-account (“IUA”), for converged: (1) communication, with means of more than one communication PASPSSC with means of a user-account login; (2) communication and web presenting, with means of a communication PASPSSC, and a web presenting PASPSSC comprising a web template, comprising “image content” and/or IM_COMB; (3) web presenting, with means of a web presenting PASPSSC, comprising a web template, of “image content” and/or IM_COMB; and/or (4) web presenting and communication, with means of a said web presenting PASPSSC, comprising a web template, of “image content”, IM_COMB, and a communication PASPSSC for “image content”, IM_COMB, and/or real-time comprising asynchronous communication with the web presenter; for PDDC comprising IC bm_of_a_ntwk. A final segment of this invention, is a system, process, procedure, product, and/or product-by-process, for real-time network translating and/or PDDC of a real-time network translated “image content” and/or IM_COMB bm_of_a_ntwk; and/or translating of IM_COMB, on a user-client, client-user, and/or desktop platform.

The said inventions, encompassing a product-by-process, of, and/or for, (1) PDDC of “image content” transmitted with means of a combined “image content” video, and audio, data packet; and/or (2) PDDC of “image content” and/or IM_COMB, transmitted with means comprising data packets, consisting with means of a user initiated dedicated communication channel-link (“UIDCL”), by means of a network.

The utility of this invention, comprises, a convenient and/or economical means for higher quality communication, time savings in transportation, and situational awareness and/or presence in communication.

The objective of this invention is an enhanced and/or new system, process, procedure, product, and/or product-by-process, comprising with means of a service software and/or software service (“SS”), for a one-, two-, and/or multi-way performance displaying during communication (“PDDC”) of asynchronous and/or real-time “image content”, by means of a communication network (“network PDDC”). A said network PDDC comprises interactive PDDC by means of a computer, phone, and/or hybrid network. A said SS, comprises a program, application, service, platform, and/or a combination thereof (“PASPC”) by means of a network (“bm_of_a_ntwk”). A communication element (“element”) is transmitted with means comprising data packets, for PDDC of “image content” by means of a network (“IC bm_of_a_ntwk”). An enhancement of the said, comprises a said transmitting with means of, a combined “image content” data packet and/or with means of a user initiated dedicated communication channel-link (“UIDCL”) by means of a network.

The said enhancements comprise input, fusion, integration, communication, and/or performance, of asynchronous and/or real-time “image content” comprising of, (1) ‘moving picture’ comprising associated audio if any, for a one- and/or multi-way network PDDC with means of a SS, means with an online, wireless handheld, and/or network computer; (2) ‘moving picture’ and/or image comprising associated audio if any, for a one-, two-, and/or multi-way, user initiated call request-acceptance (“UICRA”) network PDDC with means of an ‘internet-phone’; (3) image and/or ‘moving picture’ comprising associated audio if any, for PDDC comprising network PDDC, with means of a wireline phone, wireless handheld (comprising wireless handheld computer), and/or mobile phone; and (4) ‘moving picture’ comprising associated audio if any, with a combination of elements comprising text, hyperlink, graphics, other audio, and/or image, with means of a SS comprising a PASPC; comprising additionally a converged service software and/or software service platform (“Converged Platform”), comprising a converged software platform, platform software, service platform, and/or platform service. A said Converged Platform for a NIIC, NISC, and/or NIPC (“NIC”), is presented with means comprising a user-account and/or an internet user-account (“IUA”), for PDDC comprising IC bm_of_a_ntwk. A said Converged Platform, with a centralized login, is named and described herein, as a ‘Desktop Interface Platform’ (“DI Platform”), ‘Client Desktop Platform’ (“CD Platform”), ‘Web Presentation Platform’ (“WP Platform”), ‘Client Presentation Platform’ (“CP Platform”), and/or ‘Presentation Interface Platform’ (“PI Platform”); all of said for network PDDC comprising IC bm_of_a_ntwk.

The word “image content” generally comprises, ‘moving picture’ comprising associated audio if any, and/or all forms of image comprising static and/or dynamic image comprising associated audio if any. The said word “image content” as defined for purposes of the specification, comprises asynchronous and/or real-time (1) ‘moving picture’ comprising associated audio if any, for a one- and/or multi-way network PDDC with means of a SS, means with an online, wireless handheld, and/or network computer; (2) ‘moving picture’ and/or image comprising associated audio if any, for a one-, two-, and/or multi-way, UICRA network PDDC with means of an internet-phone′; (3) image and/or ‘moving picture’ comprising associated audio if any, for PDDC comprising network PDDC, with means of a wireline phone, wireless handheld, and/or mobile phone; and/or (4) ‘moving picture’ comprising associated audio if any, with means of a Converged Platform, for network PDDC with means of an online, wireless handheld, and/or network computer; and/or image and/or ‘moving picture’ comprising associated audio if any, with means of a Converged Platform, for PDDC with means of a wireline phone, wireless handheld, and/or mobile phone. The aforesaid, going forward on this specification, are collectively referred to as “image content”, associating said word “image content”, with a device, apparatus, machine, system, process, procedure, product, and/or product-by-process, comprising bm_of_a_ntwk, as specified in (1) thru (4) herein preceding.

As defined herein, audio-visual PDDC, or PDDC, means displaying of visual performance comprising associated audio if any, with means of an electronic device, apparatus, or machine (collectively referred to hereinafter as a “device”) during communication by means comprising a network (“bm_comprising a_ntwk”); audio-visual network PDDC, or network PDDC, means a said performing bm_of_a_ntwk; visual PDDC means displaying of visual performance with means of a device during communication bm_comprising a_ntwk; the word “interactive” means a said performing with interaction control from a user, client, and/or user-client, with means of an online and/or network source, by means comprising a computer network; all of the aforesaid communication comprising: with means of a SS comprising a PASPC; and/or from, a peer-to-peer; an online, wireless handheld, and/or network computer user, client, user-client, peer, server, and/or host; a wireline phone, wireless handheld, and/or mobile phone user, client, user-client, peer, server, and/or host; for PDDC of IC bm_of_a_ntwk. The specification going forward, refers to a user, client, or user-client, generally as a “USER”.

As defined herein, a computer comprises a device consisting of, and/or connecting to, an analog and/or digital computer; a network computer comprises an online and/or network source, and/or host; a said source and/or host comprising a computer, server, and/or other host; and a ‘computer network’ consists of an online network comprising the internet, intranet, satellite computer network, and/or the like. A said computer network comprises spanning the network globe, comprising a home network, PAN, LAN, WAN, MAN, and/or the like.

As defined herein further, a phone comprises a device consisting of, and/or connecting to, an analog and/or digital phone; a wireless handheld, comprises a cordless, wireless, mobile, and/or satellite phone; and a mobile phone comprising a said phone, excluding a wireline, non-mobile wireless, and satellite phone. A wireless handheld, also comprises a wireless handheld computer that is connectable to a computer and/or phone network.

A ‘wireless network’ comprises, a wireless computer network, and/or a cellular, mobile, and/or satellite phone network; a said comprising a hybrid internet, intranet, and/or the like; and a ‘phone network’ comprises a wireline, wireless, and/or mobile phone network.

As defined herein for distinct clarification, a ‘network’ comprises of a wireline and/or wireless computer, phone, and/or hybrid network; it does not consist a television broadcast network not comprising a computer, phone, or hybrid network. A hybrid network comprises a combination of cross communicating wireline and/or wireless computer, phone, and/or other network.

For purposes of this specification, a combination of elements comprising of text, hyperlink, other audio, prior-art static image, and/or other multimedia, is referred to as “COMB”; where the said prior-art static image is product, device, and/or network dependent, and a said other multimedia comprising prior-art graphics. Similarly, a combination of elements comprising of “image content”, text, hyperlink, other audio, and/or other multimedia, is referred to as “IM_COMB” going forward on this specification. Further, for purposes of this specification, a reference to PDDC of “image content” means, PDDC of “image content” comprising COMB; and a reference to PDDC of ‘moving picture’ means, PDDC of ‘moving picture’ comprising IM_COMB.

Further, for purposes of this specification, PDDC of IC bm_of_a_ntwk, comprises, PDDC of ‘moving picture’ by means of a computer network; PDDC comprising network PDDC of “image content” with means of an internet-phone′; and/or PDDC comprising network PDDC of “image content” with means of a wireline phone, wireless handheld, and/or mobile phone.

The subject of this invention has precursors or prior-art. The first precursor being, network PDDC of static visual, and/or audio, elements with means of a website, webpage, a series and/or multiples thereof, by means of a computer network. The second precursor being, network PDDC of real-time and/or asynchronous audio element, by means of a computer or phone network. The said precursors being employed by family, relatives, friends, and/or the public, throughout the network globe.

At the time of invention, electronic communication by means of a computer and/or phone network, comprised network PDDC of limited elements that stimulate a USER's physiological senses of the ear and/or eye. To increase the human cognitive aptitude, a said electronic communication has tended to input, fuse, and/or integrate, a multitude of elements for PDDC bm_of_a_ntwk. The said elements, comprise, audio that stimulates a USER's auditory senses of the ear; and/or text, hyperlink, and/or static image that stimulate a computer USER's visual senses of the eye.

This invention presents the useful element of ‘moving picture’ for PDDC with means of a SS bm_of_a_ntwk. The term ‘moving picture’ as defined herein, means any non-static image comprising of, an image that exhibits characteristics of unconventional motion and/or moving; and/or a moving of sequential images (also known as “video”); comprising associated audio if any. The said ‘moving picture’ element, comprising the term “image content” in the prior application specification, is an enhancement of network PDDC with means of a SS, means with an online, wireless handheld, and/or network computer; and PDDC comprising network PDDC with means of a wireline phone, wireless handheld, and/or mobile phone. The word “image” as defined herein, means any static image, not comprising a moving picture, and that does not comprise motion and/or moving, during PDDC bm_of_a_ntwk. The said invention, has had been phase experimented and tested, before the prior application specification, on the fundamentals for network PDDC of “image content” by means comprising a computer network.

A segment of this invention, is an enhanced and/or new system, process, procedure, product, and/or product-by-process, of, and/or for, a SS, for a one-, two-, and/or multi-way network PDDC of asynchronous and/or real-time ‘moving picture’ bm_of_a_ntwk. Another segment of this invention, is an enhanced and/or new system, process, procedure, product, and/or product-by-process, of, and/or for, an ‘internet-phone’, for a one-, two-, and/or multi-way network PDDC, of real-time and/or asynchronous ‘moving picture’ and/or image comprising associated audio if any, bm_of_a_ntwk. A still another segment of this invention, is an enhanced and/or new system, process, procedure, product, and/or product-by process, of a wireline phone, wireless handheld, and/or mobile phone, for PDDC of “image content” by means comprising a network (“IC bm_comprising a_ntwk”). A further segment of this invention, is an enhanced and/or new system, process, procedure, product, and/or product-by-process, comprising of, and/or for, inputting, fusing, and/or integrating, of “image content”, and/or a communication program, application, service, platform, service software, software service, and/or a combination thereof (“PASPSSC”), into a Converged Platform, for: network PDDC with means comprising an online, wireless handheld, and/or network computer, network PDDC with means comprising an ‘internet-phone’, and/or PDDC comprising network PDDC with means comprising a wireline phone, wireless handheld, and/or mobile phone; a said for converged communication, communication and web presenting, web presenting, and/or web presenting and communication. A final segment of this invention, is an enhanced and/or new system, process, procedure, product, and/or product-by-process, of, and/or for, a real-time network translating and/or PDDC of a real-time network translated IM_COMB bm_of_a_ntwk; and/or translating of IM_COMB on a user-client, client-user and/or desktop platform bm_comprising a_ntwk.

In a nutshell, the subject of this invention specifically comprises, a system, process, procedure, product, and/or product-by-process, for performing asynchronous and/or real-time “image content”, for visual and/or audio-visual, (1) network PDDC with means of an online, wireless handheld, and/or network computer, (2) UICRA network PDDC with means of an ‘internet-phone’, (3) PDDC, comprising network PDDC, with means of a wireline phone, wireless handheld, and/or mobile phone, (4) network PDDC with means of a Converged Platform, means comprising a user-account and/or an IUA, and (5) PDDC of a real-time network translated IM_COMB bm_of_a_ntwk, and/or translating of IM_COMB in a user-client, client-user, and/or desktop platform.

A subject of this invention, an enhanced and/or new SS for PDDC of IC bm_of_a_ntwk, is not only an enhancement over prior-art, but also solves numerous informational, social, and/or professional issues. The aforesaid requires enhancements in hardware, software, embedded systems, processes, service software, software service, and/or a combination thereof, for PDDC of IC bm_of_a_ntwk.

Another subject of this invention, is an enhanced and/or new ‘internet-phone’, for a UICRA network PDDC of real-time and/or asynchronous IC bm_of_a_ntwk. The said comprises presenting visual and/or audio visual, end-user to end-user, network PDDC, whereby enhancing informational, social, and/or professional communication, by means thereof.

Another subject of this invention, is presenting a wireline phone, wireless handheld, and/or mobile phone, for PDDC of IC bm_comprising a_ntwk. The aforesaid comprises presenting visual and/or audio-visual PDDC of “image content”, whereby enhancing the capabilities of, and/or communication with means of, a said wireline phone, wireless handheld, and/or mobile phone.

A further subject of this invention, is an enhanced and/or new Converged Platform with means of a user-account and/or an IUA, for, and/or of, inputting, fusing, and/or integrating of asynchronous and/or real-time “image content”, IM_COMB, and/or a communication PASPSSC, for PDDC comprising IC bm_of_a_ntwk. A said Converged Platform, presents for convergence in communication, communication and web presenting, web presenting, and/or web presenting and communication, referred to herein as “C_CWP_WP_and/or_WPC”, for PDDC comprising IC bm_of_a_ntwk. The aforesaid enhancement of, and/or for, a Converged Platform, presents for multi-functionality and/or capability, in contrast to presenting a standalone or independent SS, for PDDC of IC bm_of_a_ntwk. A said Converged Platform, presents enhancements in visual and/or audio-visual PDDC of IC bm_of_a_ntwk, with means comprising an organized, hierarchical, and/or structurally efficient, Converged Platform from a one-stop-shop location.

The resultant utility of this invention comprises enhancements in Network Integrated (i) Information, (ii) Social, and/or (iii) Professional Communication, respectively referred to herein as “NIIC”, “NISC”, and “NIPC”.

The abbreviation NIIC, comprises of an enhanced, new, and/or converged solution for PDDC of IM_COMB bm_of_a_ntwk, on matter relating to ‘information’. The abbreviation NISC, comprises of an enhanced, new, and/or converged solution for PDDC of IM_COMB bm_of_a_ntwk, on matter relating to society, social interacting, and/or social sciences. The abbreviation NIPC, comprises of an enhanced, new, and/or converged solution for PDDC of IM_COMB bm_of_a_ntwk, comprising of NIIC and/or NISC, on matter relating to, and/or associating with, a profession and/or business.

The said invention presents an enhanced and/or new solution, for PDDC of IM_COMB bm_of_a_ntwk, which stimulates a USER's visual comprising auditory senses, for the perception of real-life events. The said enhancements, present resultant solutions that are utilitarian, economical, and/or dynamic, with means of an online, wireless handheld, and/or network computer; an ‘internet-phone’; and/or a wireline phone, wireless handheld, and/or mobile phone.

### BACKGROUND OF THE INVENTION

The subject of this invention relates to an enhanced and/or new network integrated (i) information, (ii) social, and/or (iii) professional communication, with means of a service software, software service, device, network, and/or a combination thereof, for PDDC of IC bm_of_a_ntwk. The said invention relates to a disclosure, under a duty to preserve confidentiality and secrecy, made in 1998, upon experimentation, and testing, that began earlier relating thereto. The invention, along with progress thereupon, is described herein without addition of new matter.

### (i) Network Integrated Information Communication (“NIIC”)

Network integrated information communication, namely “NIIC”, comprises information dissemination bm_of_a_ntwk. An enhanced and/or new NIIC presents a said dissemination, comprising of, and/or for, PDDC of IC bm_of_a_ntwk.

An enhanced and/or new NIIC is presented to a USER, with means comprising an enhanced, new, and/or converged SS, for PDDC of IC bm_of_a_ntwk. A said NIIC as defined herein, comprises PDDC of IC bm_of_a_ntwk, to and/or from family, relatives, friends, and/or the public.

The prior-art elements in network PDDC for NIIC, by means of, (1) a computer network comprises text, hyperlink, audio, and/or static image, with means comprising a website and/or webpage, and (2) a phone network comprises audio, and/or limited text.

The process of PDDC of ‘moving picture’ with means of a SS by means of a computer network, and PDDC of image, ‘moving picture’, and/or associated audio if any, with means of a wireline phone, wireless handheld, and/or mobile phone, is an enhancement of, and/or for, NIIC. A further enhancement of, and/or for, NIIC, is in presenting to a USER, an enhanced, new, and/or converged NIIC SS comprising multi-functionality and/or capability. A said enhancement of, and/or for, a SS, comprises being facilitated with means of inputting, fusing, and/or integrating of “image content”, into an existing, enhanced, and/or new PASPSSC; whereas a said convergence of, and/or for, a SS, is facilitated with means of inputting, fusing, and/or integrating of “image content” and/or a PASPSSC into a Converged Platform; either of said, for presenting an enhanced, new, and/or converged solution, of, and/or for, NIIC.

The aforesaid, not only present higher quality solutions for visual and/or audio-visual perception of the subject information, but also comprises presenting character, dynamics, interactivity, and/or situational awareness, in PDDC of IM_COMB bm_of_a_ntwk.

To encapsulate, the resultant advancement of, and/or for, NIIC upon this invention, is the enhanced qualitative dissemination of information bm_of_a_ntwk, to hear, vision, and/or search the said information as performed and/or during performance.

A few examples of a said enhancement of, and/or for, NIIC comprises presenting a website and/or webpage: (1) of news information comprising ‘moving picture’; (2) of an on-demand and/or real-time television news for user selecting; (3) of an internet search engine of, and/or for, “image content”; (4) advertisement of ‘moving picture’ comprising COMB; and/or (5) of “image content” with means of a wireless platform, mobile platform, wireline phone, wireless handheld, and/or mobile phone; wherein the preceding examples comprise a SS for PDDC of IC bm_of_a_ntwk.

### (ii) Network Integrated Social Communication (“NISC”)

Network integrated social communication, namely “NISC”, comprises social communication bm_of_a_ntwk. A said communication comprises matter relating to society, social interacting, and/or social sciences. An enhanced and/or new NISC presents a said communication, comprising of, and/or for, PDDC of IC bm_of_a_ntwk.

An enhanced and/or new NISC is presented to a USER, with means comprising an enhanced, new, and/or converged SS, for PDDC of IC bm_of_a_ntwk. A said NISC as defined herein, comprises PDDC of IC bm_of_a_ntwk in personal and/or social communication, to and/or from family, relatives, friends, and/or the public.

The prior-art elements in network PDDC for NISC, by means of, (1) a computer network comprises text, hyperlink, audio, and/or static image, with means comprising a website and/or webpage, and (2) a phone network comprises audio, and/or limited text.

The process of PDDC of ‘moving picture’ with means of a SS by means of a computer network, and PDDC of image, ‘moving picture’, and/or associated audio if any, with means of a wireline phone, wireless handheld, and/or mobile phone, is an enhancement of, and/or for, NISC. A further enhancement of, and/or for, NISC, is in presenting to a USER, an enhanced, new, and/or converged NISC SS comprising multi-functionality and/or capability. A said enhancement of, and/or for, a SS, comprises being facilitated with means of inputting, fusing, and/or integrating of “image content”, into an existing, enhanced, and/or new PASPSSC; whereas a said convergence of, and/or for, a SS, is facilitated with means of inputting, fusing, and/or integrating of “image content” and/or a PASPSSC into a Converged Platform; either of said, for presenting an enhanced, new, and/or converged solution, of, and/or for, NISC.

The aforesaid, not only present higher quality solutions for visual and/or audio-visual perception of the subject information, but also comprises presenting character, dynamics, interactivity, and/or situational awareness, in PDDC of IM_COMB bm_of_a_ntwk. A NISC, comprises similarities to NIIC as described in section (i) hereinbefore. The contrast being, that the subject of NISC relating to society, social interacting, and/or social sciences.

To encapsulate, the resultant advancement of, and/or for, NISC upon this invention, is the enhanced qualitative social communication and/or interacting bm_of_a_ntwk, to hear, vision, and/or search the said as performed and/or during performance.

A few examples of a said enhancement of, and/or for, NISC comprises presenting: (1) a website and/or webpage of, and/or for, social communication comprising PDDC of “image content”; (2) an internet-phone for social interacting comprising a one-, two-, and/or multi-way PDDC of real-time and/or asynchronous “image content”; (3) a website and/or webpage comprising a ‘moving picture’ of a graduation, vacation, wedding, and/or social event; (4) a website and/or webpage comprising a ‘moving picture’ originating abroad, for a USER selecting and/or viewing; (5) a website and/or webpage of a television program, that comprises no reception in the neighborhood; and/or (6) presenting the aforesaid with “image content”, means with a wireless platform, mobile platform, wireline phone, wireless handheld, and/or mobile phone; wherein the preceding examples comprise a SS for PDDC of IC bm_of_a_ntwk.

(iii) Network Integrated Professional Communication (“NIPC”)

Network integrated professional communication, namely “NIPC”, comprises NIIC as described in section (i), and/or NISC as described in section (ii), hereinbefore. However, the contrast is that a said communication and/or interacting comprises matter relating to, and/or associating with, a profession and/or business. A NIPC as defined herein, comprises professional and/or business communication bm_of_a_ntwk, comprising family, relatives, friends, and/or the public. An enhanced and/or new NIPC presents a said communication and/or interacting, comprising of, and/or for, PDDC of IC bm_of_a_ntwk.

The prior-art elements in network PDDC for NIPC, by means of, (1) a computer network comprises text, hyperlink, audio, and/or static image, with means comprising a website and/or webpage, and (2) a phone network comprises audio, and/or limited text.

A few examples of a said enhancement of, and/or for, NIPC comprises presenting: (1) a professional and/or business website and/or webpage comprising of, and/or for, a ‘moving picture’; (2) an ‘internet-phone’ for a professional and/or business based one-, two-, and/or multi-way PDDC of IC bm_of_a_ntwk; (3) a professional and/or business based intranet website, webpage, and/or SS comprising ‘moving picture’; (4) an advertising, marketing, and/or sales, comprising PDDC of a ‘moving picture’; and/or (5) presenting the aforesaid with “image content”, means with a wireless platform, mobile platform, wireline phone, wireless handheld, and/or mobile phone; wherein the preceding examples comprise a SS for PDDC of IC bm_of_a_ntwk.

an Enhanced and/or New Service Software and/or Software Service (“SS”)

As at the time of invention, a NIIC, NISC, and/or NIPC SS comprised of: a website and/or webpage comprising text, hyperlink, audio, and/or static image; an e-mail comprising text, hyperlink, and/or a file attachment; a pager comprising text; a computer message and/or chat comprising text; a wireless handheld computer comprising text and/or audio; and a wireline phone, wireless handheld, and/or mobile phone comprising audio and/or limited text.

The drawback of the aforesaid, was that a said SS presented only the said basic elements, to a USER, for PDDC bm_of_a_ntwk. To elaborate further, an e-mail was not capable of PDDC of “image content” from therewithin, without the need for porting an attached “image content” file off therefrom; while a wireline phone, wireless handheld (comprising a wireless handheld computer), and/or mobile phone device was not capable of PDDC of IC bm_comprising a_ntwk.

This invention, whereupon, presents an enhanced and/or new system, process, procedure, product, product-by-process, and/or service, of, and/or for, NIIC, NISC, and/or NIPC, comprising similar to an e-mail or phone SS, a computer or phone device, and/or a communication with means thereof. The said enhancements present for input, fusion, and/or integration into a SS, of (1) “image content” for PDDC bm_of_a_ntwk; and/or (2) a PASPSSC for PDDC comprising IC bm_of_a_ntwk.

The enhancement of a said fused, integrated, and/or converged SS, presents for PDDC comprising IC bm_of_a_ntwk, comprising with means of a Converged Platform. The objective of a said enhancement, is for averting any requirement for porting a said attached “image content” file off from a said SS for PDDC, such as to another PASPSSC. The aforesaid whereof, presents an enhanced and/or new system, process, procedure, product, and/or product-by-process, of, and/or for, a SS, whereby facilitating higher quality visual and/or audio-visual solutions, for PDDC of IC bm_of_a_ntwk.

Another drawback of NIIC, NISC, and/or NIPC, is that the aforesaid is standalone and/or independent, in contrast to being converged. The said oftentimes requires an online, wireless handheld, and/or network computer USER, or a wireline phone, wireless handheld, and/or mobile phone USER, for accessing, using, and/or browsing the aforesaid, with means comprising more than one service software, software service, and/or user-account; comprising logging thereinto with means of separate and/or independent user-accounts and/or passwords. The limited functionality and/or capability, of a said standalone and/or independent SS, presents to a USER an unorganized, cost in-effective, and/or inadequate means, for PDDC of IC bm_of_a_ntwk. A segment of this invention, presents enhancements for mitigating said shortcomings, while presenting to a USER, an enhanced, new, and/or. Converged Platform, with means of a user-account comprising an IUA, for PDDC comprising IC bm_of_a_ntwk.

A said Converged Platform, presents a converged solution comprising multi-program, application, service, and/or platform functionality and/or capability. A said convergence, facilitates an organized, cost effective, and/or adequate means, for visual and/or audio-visual PDDC comprising IC bm_of_a_ntwk.

### BRIEF DESCRIPTION OF THE DRAWINGS

The objectives of this invention will become more apparent, and the invention best understood from the following description of Network Integrated Communication (“NIC”), when read in reference to the accompanying drawings, wherein:

FIG. 1: Illustrates a prior-art e-mail service software and/or software service, by means of a computer network.

FIG. 2: Illustrates a prior-art ‘internet-phone’, for PDDC of audio and/or limited text, by means of a computer network.

FIG. 3: Illustrates a prior-art wireline phone, before enhancing for PDDC of IC bm_comprising a_ntwk.

FIG. 4: Illustrates a prior-art wireless handheld device, before enhancing for PDDC of IC bm_comprising a_ntwk.

FIG. 5: Illustrates a prior-art mobile phone, before enhancing for PDDC of IC bm_comprising a_ntwk.

FIG. 6: Illustrates a prior-art wireless handheld computer, namely a personal digital assistant (“PDA”), before enhancement for PDDC of IC bm_comprising a_ntwk.

FIG. 7: Illustrates a prior-art electronic text communication device, namely a ‘pager’.

FIG. 8: Illustrates a prior-art command line based two-way pager, and/or chat, service software and/or software service, by means of a network.

FIG. 9: Illustrates a prior-art real-time chat service software and/or software service, with means of an online and/or network computer.

FIG. 10: Illustrates a prior-art of presenting a website, webpage, a series and/or multiples thereof, for PDDC of COMB by means of a computer network.

FIG. 11: The invention of, and/or for, PDDC of ‘moving picture’ with means of a service software and/or software service, comprising a website and/or webpage, by means of a computer network.

FIG. 12: The invention of, and/or for, PDDC of “image content” with means of an ‘internet-phone’, by means of a network.

FIG. 13: The invention of, and/or for, PDDC of “image content” with means of a wireline phone, wireless handheld, and/or mobile phone, bm_comprising a_ntwk.

FIG. 14: The invention of, and/or for, presenting a Converged Platform for communication, or communication and web presenting, by means of a network.

FIG. 15: The invention of, and/or for, presenting a Converged Platform for web presenting, or web presenting and communication, by means of a network.

FIG. 16: The invention of presenting an enhanced and/or new service software and/or software service, for PDDC of “image content”, with means consisting of a UIDCL by means of a network.

FIG. 17: Illustrates a client-server for NIC, for PDDC comprising IC bm_of_a_ntwk.

FIG. 18: Illustrates an enhanced and/or new ‘internet-phone’ for PDDC of “image content”, with means comprising data packets, comprising with means of a UIDCL, by means of a network.

FIG. 19: Illustrates an enhanced and/or new wireline phone, for PDDC of IC bm_comprising a_ntwk.

FIG. 20: Illustrates an enhanced and/or new wireless handheld, for PDDC of IC bm_comprising a_ntwk.

FIG. 21: Illustrates an enhanced and/or new mobile phone, for PDDC of IC bm_comprising a_ntwk.

FIG. 22: Illustrates an enhanced and/or new wireless handheld computer, for PDDC of IC bm_comprising a_ntwk.

FIG. 23: Illustrates an enhanced and/or new service software and/or software service, namely a website, for PDDC of IC bm_of_a_ntwk.

FIG. 24: Illustrates a Converged Platform, namely a CD Platform, for, and/or of, an IUA holder, for converged communication and web presenting for PDDC comprising IC bm_of_a_ntwk.

FIG. 25: Illustrates a Converged Platform, namely a CP Platform, for, and/or of, an IUA holder, for converged web presenting and communication for PDDC comprising IC bm_of_a_ntwk.

FIG. 26: Illustrates a converged web presentation of an IUA holder, during presenting to another, for PDDC comprising IC bm_of_a_ntwk.

FIG. 27: Illustrates an elemental coverage of a one- and/or two-way PDDC comprising real-time and/or asynchronous IC bm_of_a_ntwk. C.I.P. Specification—“Prior Application Specification B”: Begin

FIG. 28: Illustrates a real-time network translating in a Native language local server, from the English language to a Native language, and vice versa, for PDDC of real-time network translated IM_COMB by means of a network.

FIG. 29: Illustrates a real-time network translating in an English language local server, from a Native language to the English language, and vice versa, for PDDC of real-time network translated IM_COMB by means of a network.

FIG. 30: Illustrates translating from a Native language to another Native language, with means of an English language translator being an intermediary, for PDDC of translated IM_COMB by means comprising a network.

========C.I.P. Specification—“Prior Application Specification B”: End

### A SYSTEM, PROCESS, PROCEDURE, AND/OR PRODUCT FOR NIC

As stated hereinbefore, a USER gains access to, and/or using of, NIC with means of an online, wireless handheld, and/or network computer, and/or a wireline phone, wireless handheld, and/or mobile phone, bm_of_a_ntwk. A said USER device establishes network connecting, with means of a service provider, means comprising a computer, phone, and/or hybrid network. A said USER, on establishing a said network service, gains access to, and/or using of, a NIC SS comprising a PASPSSC bm_of_a_ntwk.

As defined herein, a NIC SS for a computer network, is referred to as a “CNS”, and is made available to an online, wireless handheld, and/or network computer USER, by means of a computer network. A NIC SS for a phone network, is referred to as a “PNS”, and is made available to a wireline phone, wireless handheld, and/or mobile phone USER, by means of a phone network. A NIC SS for a hybrid network is referred to as a “NS”, and is made available to, an online, wireless handheld, and/or network computer USER, and/or a wireline phone, wireless handheld, and/or mobile phone USER, by means of a computer, phone, and/or hybrid network.

A NIC CNS is either subscription-less, or alternatively, subscription-based. If a said CNS is subscription-less, but requires an IUA, a USER gains access to, and/or using of, a said CNS, by means of setting up of an IUA and thereof logging thereinto. However, if a said CNS is subscription-based, a USER gains access to, and/or using of, a said CNS, with means of subscribing thereto, comprising setting up of an IUA and thereof logging thereinto. A USER, on gaining access to, and/or logging into, a public account, subscription-less IUA, or subscription-based account, gains access to, and/or using of, a CNS comprising a PASPSSC, for PDDC of “image content” by means of a computer network.

Similarly, a USER, gains access to, and/or using of, a NIC PNS with means of a public account, subscription-less user-account, and/or subscription-based account, by means of a phone network. A said USER, employs the means of a PNS comprising a PASPSSC, for gaining access to, and/or use of, a PNS comprising a PASPSSC, for PDDC of “image content” by means of a phone network.

Similarly, a USER, gains access to, and/or using of, a NIC NS with means of a public account, subscription-less user-account, and/or subscription-based account, by means of a computer, phone, and/or hybrid network. A said USER, employs the means of a NS comprising a PASPSSC, for gaining access to, and/or using of, a NS comprising a PASPSSC, for PDDC of “image content” by means of a computer, phone, and/or hybrid network.

A USER, employs the means of a CNS, PNS, and/or NS, for gaining access to, and/or using of, a NIIC, NISC, and/or NIPC, for PDDC of IC bm_of_a_ntwk, which incorporate enhancements in network communication standards and/or protocols. However, a CNS, PNS, and/or NS for NIPC, may comprise additional entity authorization requirements, comprising for setting up of a user-account, gaining access thereto, logging thereinto, and/or using thereof, for PDDC of IC bm_of_a_ntwk. A said USER, with any required entity authorization, gains access to, and/or using of, a NIPC CNS, PNS, and/or NS, for PDDC of IC bm_of_a_ntwk.

Examples of a NS for NIIC, comprises news, “image content” search, and/or the like; a NS for NISC, comprises e-mail, ‘internet-phone’, and/or the like; and a NS for NIPC, comprises an entity-based news, “image content” search, e-mail, ‘intranet-phone’, and/or the like; that is employed by an online, wireless handheld, and/or network computer USER, and/or a wireline phone, wireless handheld, and/or mobile phone USER, with means of a SS for PDDC of “image content” by means of a computer, phone, and/or hybrid network.

### SUMMARY OF THE INVENTION

The invention presents an enhanced and/or new system, process, procedure, product, product-by-process, and/or service, for PDDC of visual and/or audio-visual asynchronous, and/or real-time:
1. ‘moving picture’ with means of a SS, comprising a website and/or webpage, means with an online, wireless handheld, and/or network computer, bm_of_a_ntwk;
2. “image content” for an interactive one-, two-, and/or multi-way, UICRA PDDC with means of an ‘internet-phone’, bm_of_a_ntwk;

C. Specification—“Prior Application Specification”: Begin
3. “image content” with means of a wireline phone, wireless handheld, and/or mobile phone, bm_comprising a_ntwk;

C. Specification—“Prior Application Specification”: End
4. “image content” with means of an enhanced and/or new CNS, PNS, and/or NS, comprising of, and/or for, inputting, fusing, and/or integrating of, “image content” for PDDC bm_of_a_ntwk; a communication and/or web presenting PASPSSC, comprising “image content”, for converged C_CWP_WP_and/or_WPC, with means of a Converged Platform, means with a user-account and/or an IUA, for, (1) self-use in communication; and/or (2) web presenting to a host, another user-account holder, and/or the public (“another”); and

C.I.P. Specification—“Prior Application Specification B”: Begin
5. real-time network translated IM_COMB bm_of_a_ntwk. A said translating is facilitated with means of a real-time network translating in a local and/or remote server, host, user-client, client-user, and/or desktop platform, for PDDC of a real-time network translated IM_COMB bm_of_a_ntwk; and/or translating of IM_COMB with means of a translator in a user-client, client-user, and/or desktop platform, a said desktop platform comprising a desktop operating system platform, for PDDC of translated IM_COMB bm_comprising a_ntwk.

C.I.P. Specification—“Prior Application Specification B”: End

C. Specification—“Prior Application Specification”: Begin
6. a PDDC of “image content” and associated audio if any, transmitted with means of a combined “image content” data packet, consisting said “image content” image and audio data, bm_of_a_ntwk;

C. Specification—“Prior Application Specification”: End

C. Specification—“Prior Application Specification”: Begin
7. a PDDC of “image content” and associated audio if any, and/or IM_COMB, transmitted with means comprising data packets, consisting with means of a UIDCL bm_of_a_ntwk;

C. Specification—“Prior Application Specification”: End

### DESCRIPTION OF THE SPECIFICATION

The specification herein, begins by describing the prior-art system, process, procedure, product, and/or product-by-process, of, and/or for, provisioning a SS; and the process and/or procedure of transmitting and/or receiving elements of a said, by a USER, server, and/or host. A said process and/or procedure is described for a SS, comprising a PASPSSC, by means of a computer, phone, and/or hybrid network.

An aforesaid process and/or procedure, for PDDC of COMB, by means of a hybrid network, is an overlap of a computer and/or phone communication by means respectively of a computer and/or phone network, with additional means for a NS, employing hybrid communication standards and/or protocols. However, this invention does not independently claim any of said communication standards nor protocols, for PDDC of elements, by means either of a computer, phone, nor hybrid network.

The process and/or procedure for presenting, accessing, and/or using of a NIC CNS and/or PNS, is similar respectively to that of a website, e-mail, and/or phone, comprising additional requirements for asynchronous and/or real-time PDDC of “image content”, by means of a computer and/or phone network.

A hybrid network USER access to, and/or using of, a NS for PDDC of “image content” by means of a hybrid network, is similar to a computer or phone USER access to, and/or using of, a public and/or user-account based CNS or PNS, by means respectively of a computer, and phone network.

The provisioning of a NIC NS is unique to that of a CNS, and PNS, primarily in access to hybrid communication, and/or a host, by means of a hybrid network. A USER access to a NS by means of a hybrid network communication channel, is similar to accessing an e-mail and/or phone with means of the internet by means of a computer network, and/or calling a phone by means of a phone network, comprising additional requirements for asynchronous and/or real-time PDDC of “image content” by means of a hybrid network.

A SS for PDDC of “image content”, is facilitated by means of accessing and/or using of a said, directly from a peer, server, and/or host bm_comprising a_ntwk. A said SS provider, presents a said to a USER, with means of the prior-art of presenting a SS with means comprising an online, wireless, and/or network peer, server, and/or host. A USER gains access to a said, with means comprising, directly from a peer, server, and/or host, and/or with means comprising a web browser, for PDDC of IC bm_of_a_ntwk.

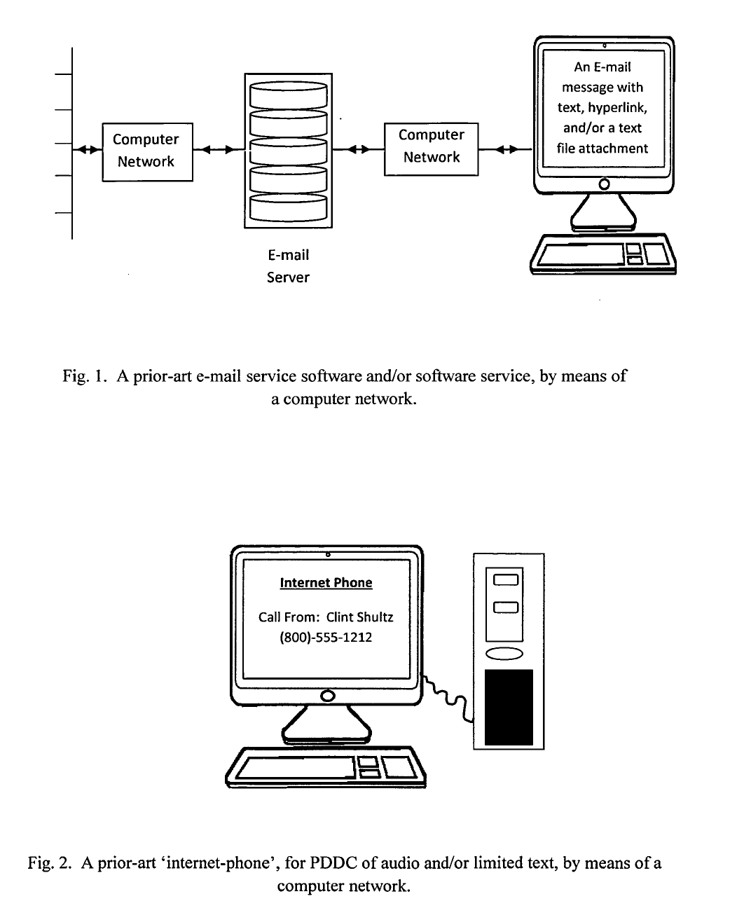

FIG. 1 illustrates a prior-art SS, comprising a PASPSSC, employing a local and/or remote server and/or host, where a USER gains access thereto, and/or using thereof, with means comprising a web browser, by means of a computer network. The said illustration shows a prior-art e-mail SS. At the time of the invention, a said e-mail CNS had capability for attaching a text-file onto an e-mail message. A said e-mail message, comprised of text, hyperlink, and/or a text-file attachment.

FIG. 2 illustrates a prior-art internet-phone′ for PDDC of audio and/or limited text, by means of a computer network. The said illustration shows a said internet-phone′ PDDC of audio and/or limited text, with means of an online and/or network computer, by means of a computer network.

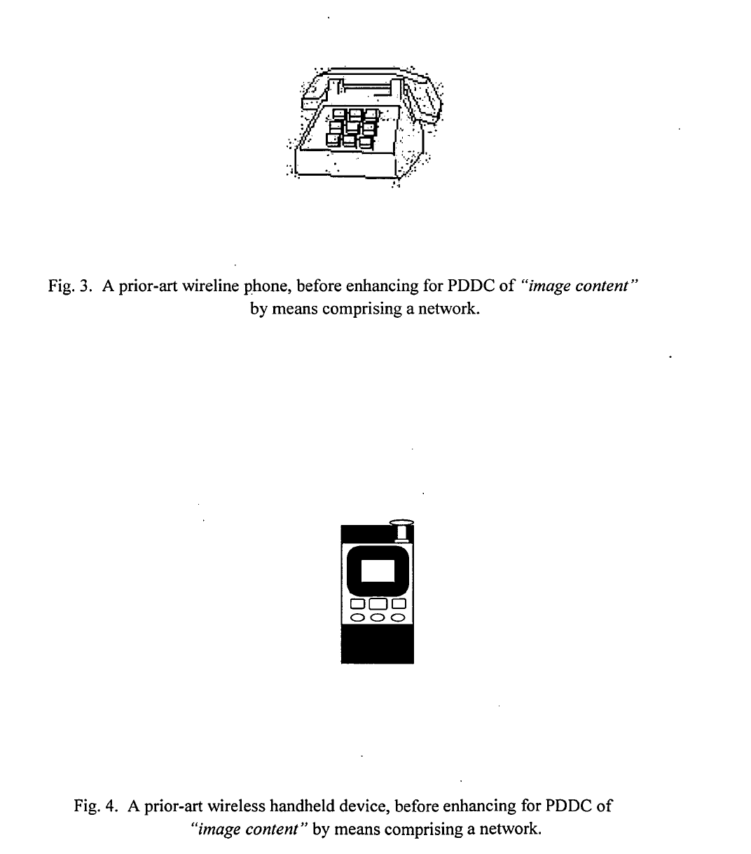

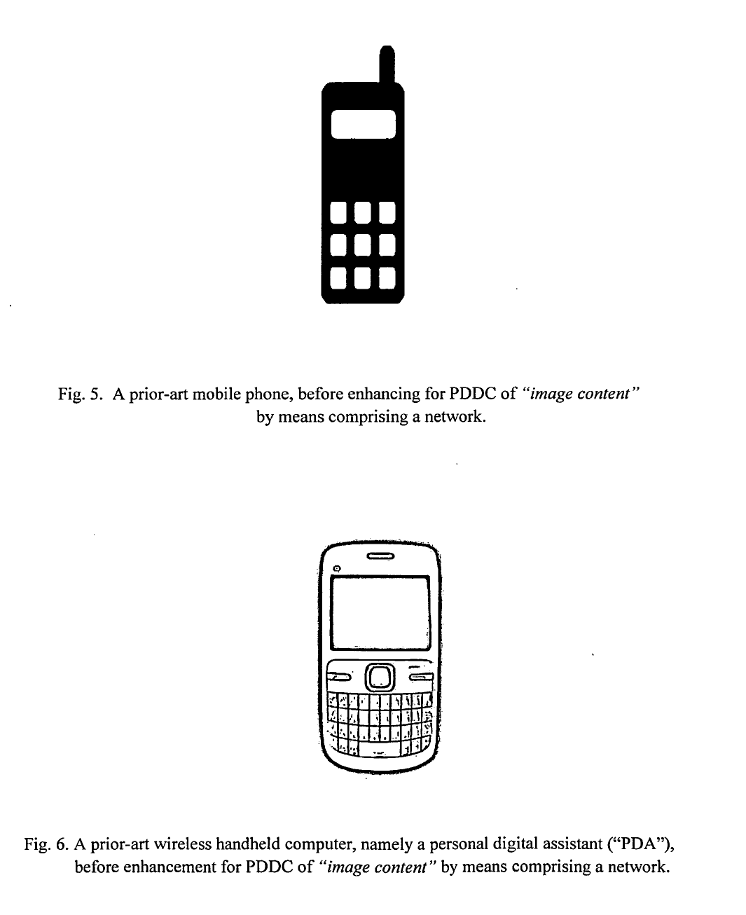

FIGS. 3, 4, and 5, respectively illustrate a prior-art wireline phone, wireless handheld, and mobile phone device, which comprise being enhanced for PDDC of IC bm_comprising a_ntwk.

FIG. 6 illustrates a prior-art wireless handheld computer, namely a personal digital assistant (“PDA”), which comprises being enhanced for PDDC of IC bm_comprising a_ntwk.

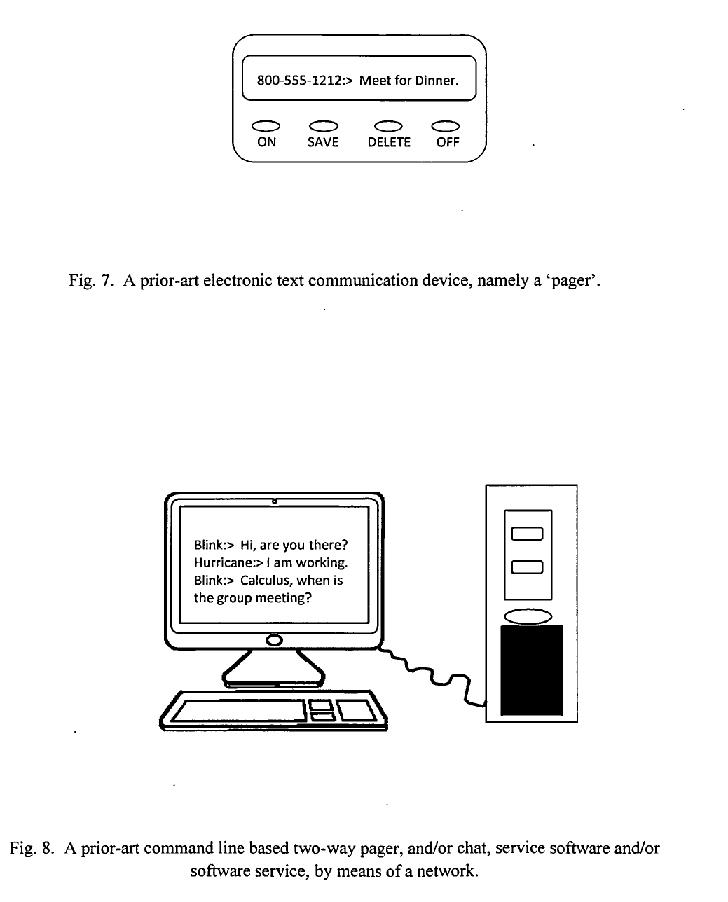

FIG. 7 illustrates a prior-art electronic text communication device, namely a ‘pager’. A said pager is used for one-way communication of a text message, with means comprising a paging SS.

FIG. 8 illustrates a prior-art command line based two-way pager and/or chat SS, for PDDC of command line text, with means of an online and/or network computer, by means of a computer network. A said CNS, comprises capability for pinging and ponging command-line based page and/or chat, by means of a computer network.

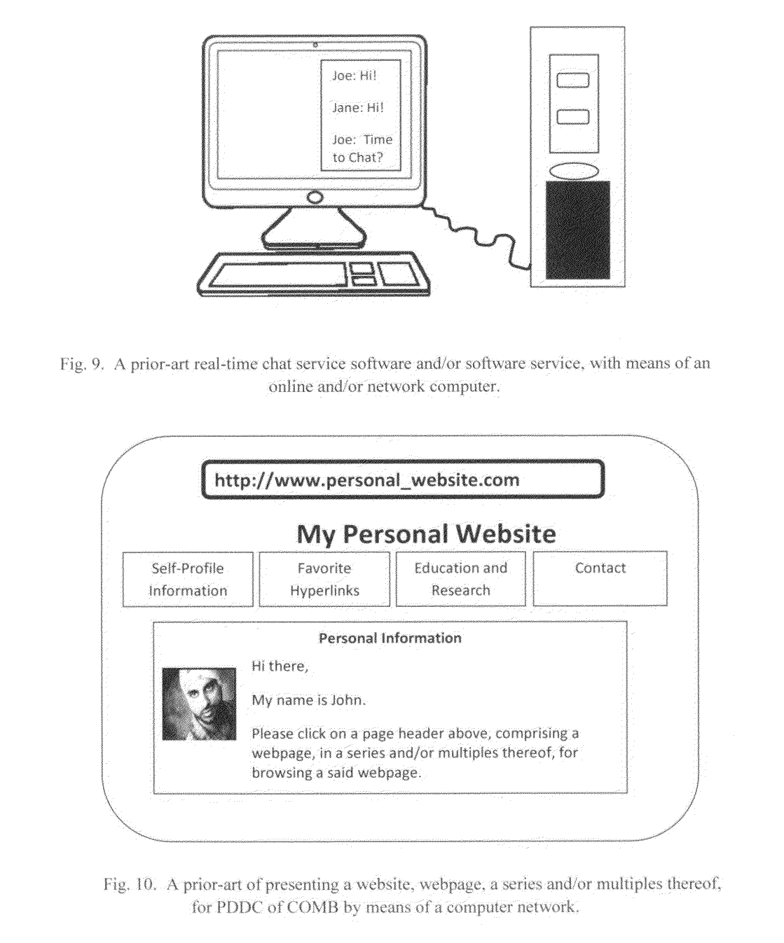

FIG. 9 illustrates a real-time one- and/or two-way chat SS, which presents for PDDC of text, with means of an online and/or network computer, by means of a computer network. The said illustration shows a real-time chat CNS, for PDDC of real-time text messages, by means of a computer network.

FIG. 10 illustrates a prior-art of presenting a SS, namely a website, webpage, a series and/or multiples thereof, for PDDC of COMB, by means of a computer network. A said webpage comprises a header tag, means comprising with which a browsing USER selects a said webpage for network PDDC. A said website and/or webpage CNS comprises being utilized for PDDC of COMB, by means of a computer network.

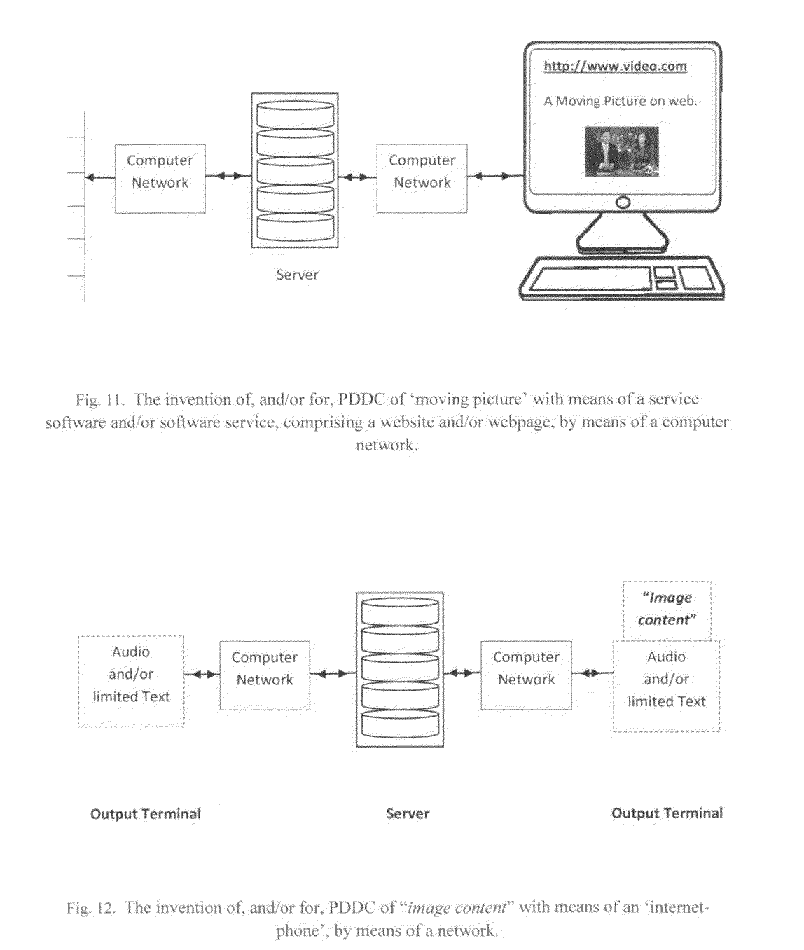

FIG. 11 illustrates a segment of this invention, of, and/or for, PDDC of ‘moving picture’ with means of a SS comprising a website and/or webpage, by means of a computer network. The said illustration shows a PDDC of ‘moving picture’ to a USER from a website addressed http://www.video.com, with means comprising a web browser, by means of a computer network.

FIG. 12 illustrates another segment of this invention, of, and/or for, PDDC of “image content” with means of an ‘internet-phone’ bm_of_a_ntwk. Here, an ‘internet-phone’ USER, performs a one-, two-, and/or multi-way PDDC of image, moving picture, and/or associated audio if any, bm_of_a_ntwk.

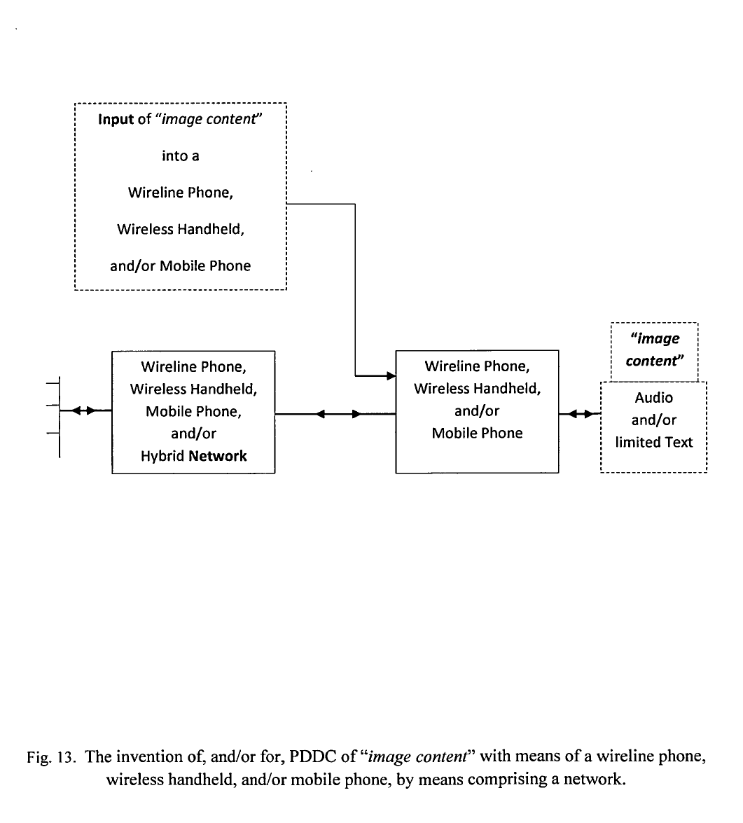

FIG. 13 illustrates a yet another segment of this invention, of, and/or for, PDDC of “image content” with means of a wireline phone, wireless handheld, and/or mobile phone, bm_comprising a_ntwk. A PDDC of image and/or ‘moving picture’ with means of a wireline phone, wireless handheld, and/or mobile phone, is an enhancement over prior-art, and facilitates for PDDC of IC bm_of_a_ntwk.

Another segment of this invention, is convergence of communication, communication and web presenting, web presenting, and/or web presenting and communication, referred to herein as C_CWP_WP_and/or_WPC.

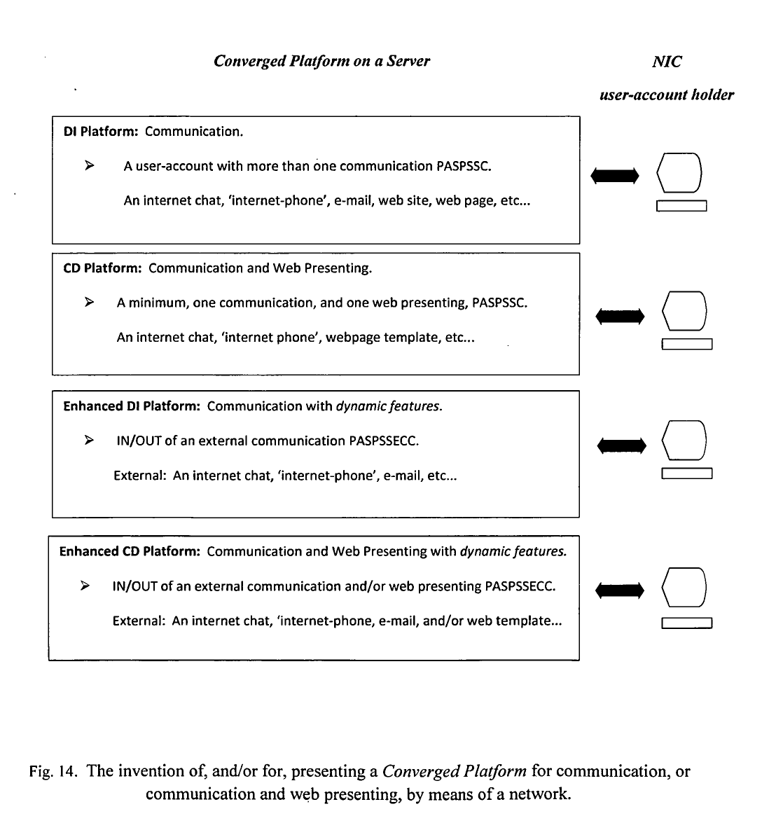

FIG. 14 illustrates a segment of the aforesaid, of, and/or for, presenting a Converged Platform for communication, and/or communication and web presenting, bm_of_a_ntwk. A said platform, with means of a user-account and/or an IUA, of, and/or for, (1) communication, namely a DI Platform, consists more than one communication PASPSSC; and/or (2) communication and web presenting, namely a CD Platform, consists a web presenting and communication PASPSSC; for PDDC comprising IC bm_of_a_ntwk. An enhancement of the said, with means of, (3) an enhanced DI Platform, consists capability of, and/or for, inputting, fusing, integrating, and/or porting, of an external communication program, application, service, platform, service software, software service, an element, content, and/or a combination thereof (“PASPSSECC”) thereinto and/or off-therefrom; and/or (4) an enhanced CD Platform, consists capability of, and/or for, inputting, fusing, integrating, and/or porting, of an external web presenting and/or communication PASPSSECC thereinto and/or off-therefrom; all of said for PDDC comprising IC bm_of_a_ntwk.

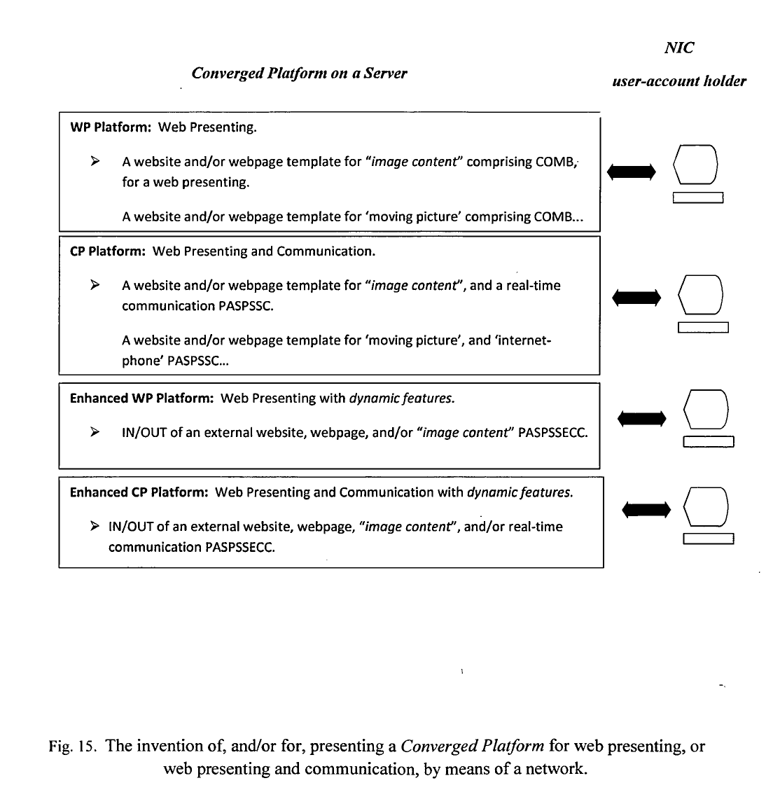

FIG. 15 illustrates another segment of a said convergence, of, and/or for, presenting a Converged Platform for web presenting, and/or web presenting and communication, bm_of_a_ntwk. A said platform with means of a user-account and/or an IUA, of, and/or for, (1) a web presentation, namely a WP Platform, consists “image content” and/or IM_COMB on a web presenting PASPSSC comprising a web template; and/or (2) a web presentation and communication, namely a CP Platform, consists “image content” and/or IM_COMB, and a communication PASPSSC, on a web presenting PASPSSC comprising a web template; for PDDC comprising IC bm_of_a_ntwk. An enhancement of the said, with means of, (3) an enhanced WP Platform, consists capability of, and/or for, inputting, fusing, integrating, and/or porting, an external “image content”, IM_COMB, and/or a web presenting PASPSSECC, thereinto and/or off-therefrom; and/or (4) an enhanced CP Platform, consists capability of, and/or for, inputting, fusing, integrating, and/or porting, an external “image content”, IM_COMB, web presenting, and/or communication PASPSSECC, thereinto and/or off-therefrom; all of said for PDDC comprising IC bm_of_a_ntwk.

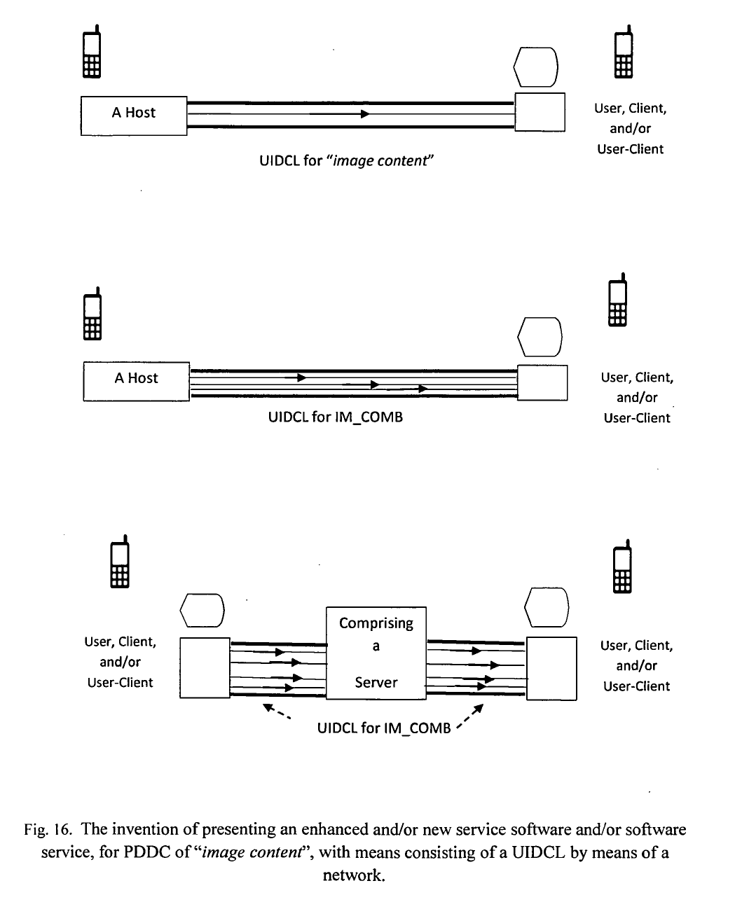

FIG. 16 illustrates an extending segment of this invention, for an enhanced and/or new SS for PDDC of “image content” and/or IM_COMB, with means consisting of a UIDCL bm_of_a_ntwk. A said enhancement on a SS, is facilitated with means of networking hardware, software, and/or embedded system, for PDDC of “image content” and/or IM_COMB, with means comprising data packets, consisting with means of a UIDCL, bm_of_a_ntwk. The diagrams on the illustration, show, (1) a UIDCL for “image content”, where a ‘moving picture’ comprises being transmitted for PDDC with means consisting a UIDCL bm_of_a_ntwk; a said transmitting may comprise a communication of ‘moving picture’ with a video image, video audio, and/or a combined data packet; (2) a UIDCL for IM_COMB, where elements are transmitted for PDDC with means consisting a UIDCL bm_of_a_ntwk; and (3) a server presence in a UIDCL for a one-, two, and/or multi-way PDDC session that consists a minimum one UIDCL for PDDC of IM_COMB bm_of_a_ntwk. A said system, process, and/or product-by-process, enhances throughput, packet loss rates, and/or the quality, of, and/or for, PDDC of IM_COMB bm_of_a_ntwk.

A said enhancement, is presented to a USER, with means of an enhanced and/or new SS, for PDDC of “image content” and/or IM_COMB, with means consisting of a UIDCL bm_of_a_ntwk. A said PDDC, is similar to a PDDC with means of a SS bm_of_a_ntwk, the contrast being that a said user initiated communication consisting of a dedicated communication channel-link for a said SS PDDC session of “image content” and/or IM_COMB, to and/or from a peer, server, host, and/or USER.

Similarly an ‘internet-phone’, wireline phone, wireless handheld, and/or mobile phone, comprises PDDC of “image content” and/or IM_COMB, with means consisting of a UIDCL by means of network. A said PDDC session, comprises a one-, two-, and/or multi-way PDDC of “image content” and/or IM_COMB, with means comprising respectively of one, two, and/or multiple UIDCLs bm_of_a_ntwk. A said PDDC session of “image content” and/or IM_COMB, with means of a SS, ‘internet-phone’, wireline phone, wireless handheld, and/or mobile phone, comprises a said extending segment of this invention, for a one-, two-, and/or multi-way PDDC of “image content” and/or IM_COMB, with means consisting of a UIDCL, by means of a network.

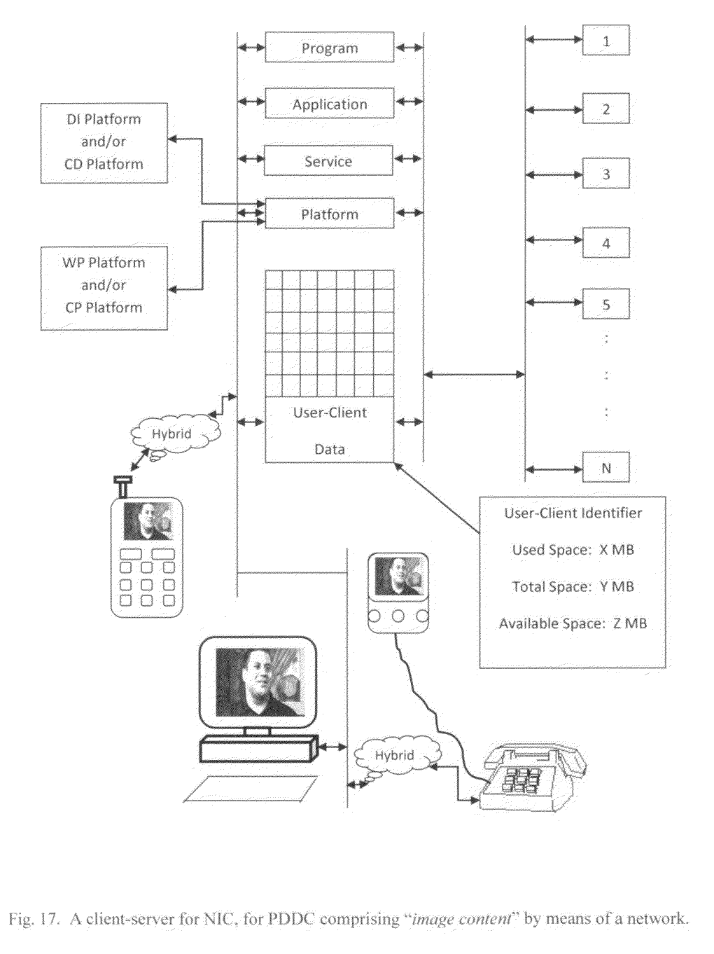

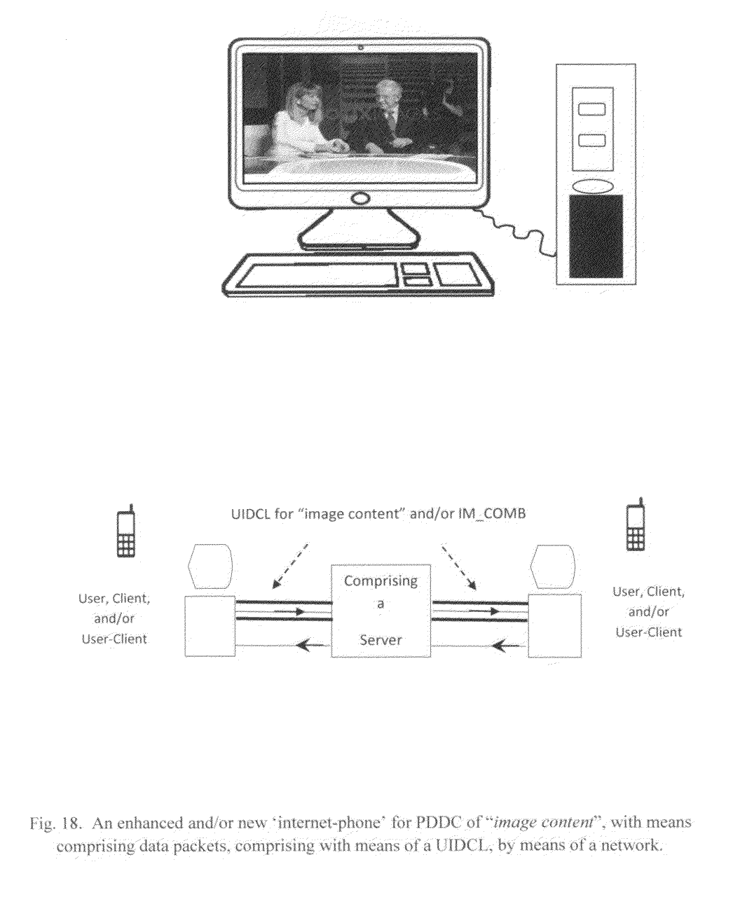

FIG. 17 illustrates a client-server for NIC, for PDDC comprising IC bm_of_a_ntwk. The said figure shows a client-server for NISC and/or NIPC. A said illustration, consisting of ‘host data’, and comprising ‘user-client data’, presents a client-server for NIIC, and comprising NISC and/or NIPC. A USER gains access to, and/or using of, a server based SS with means comprising a web browser bm_of_a_ntwk. A said process and/or procedure, is similar to the prior-art of accessing and/or using of a website, webpage, server based e-mail account, and/or internet applications. A said accessing and/or using, comprises requiring real-time comprising asynchronous communication requirements, comprising continuous minimum bit-rates, for PDDC of IC bm_of_a_ntwk.

A USER is presented an enhanced and/or new SS, upon this invention, comprising capabilities of, and/or for, (1) inputting, fusing, and/or integrating of “image content”, and/or (2) convergence comprising an existing, enhanced, and/or new PASPSSC, for PDDC comprising IC bm_of_a_ntwk. A said converged SS, with means of a user-account and/or an IUA, comprises presenting multi-functionality and/or capability with means of a CNS, PNS, and/or NS, for PDDC comprising IC bm_of_a_ntwk.

FIG. 18 illustrates an enhanced and/or new internet-phone′ for PDDC of IC bm_of_a_ntwk. Similarly, an internet-phone′ SS, comprises being employed for PDDC of “image content” with means of a wireline phone, wireless handheld, and/or mobile phone, bm_of_a_ntwk. The said figure shows an enhanced and/or new internet-phone′ during a call session, where a USER communicates with the participants shown thereon bm_of_a_ntwk. Similar to FIG. 16, the figure shows, an online, wireless handheld, and/or network computer, an internet-phone′, and/or a wireline phone, wireless handheld, and/or mobile phone, comprising a server, for PDDC of“image content” and/or IM_COMB, with means consisting of a UIDCL by means of network. A said PDDC session, may comprise more than one UIDCL, for a two- and/or multi-way communication session of IM_COMB bm_of_a_ntwk.

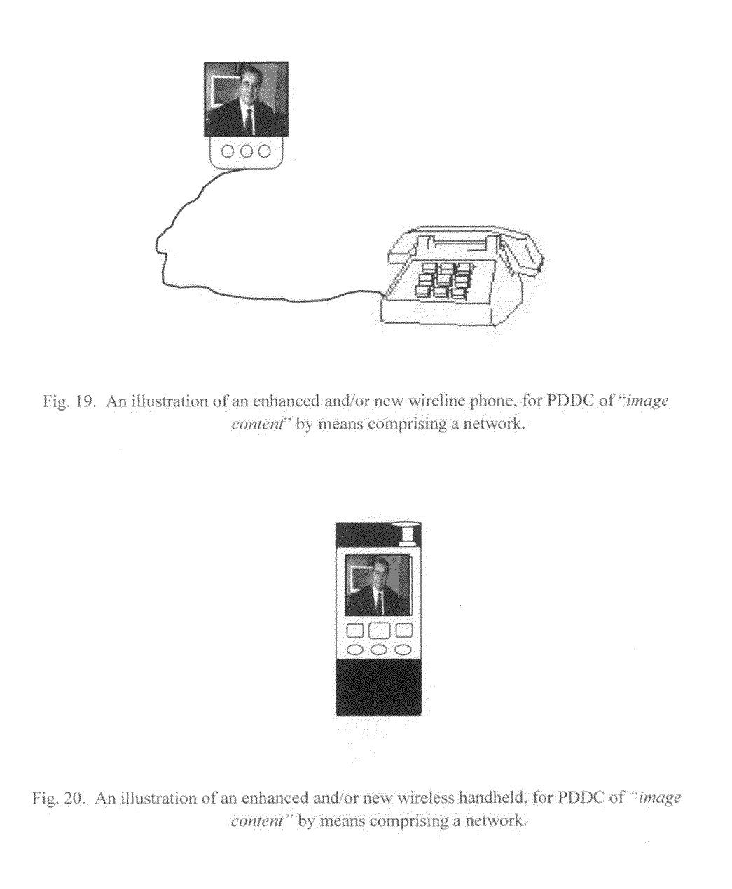

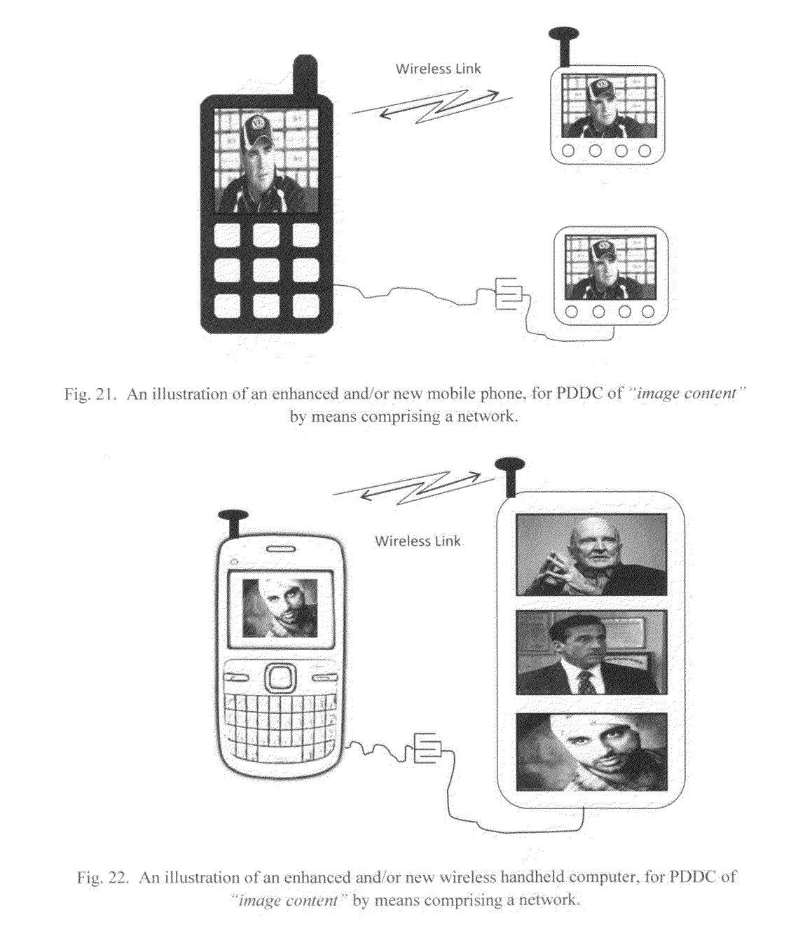

FIGS. 19, 20, and 21, respectively illustrate an enhanced and/or new wireline phone, wireless handheld, and a mobile phone; and FIG. 22 illustrates an enhanced and/or new wireless handheld computer; for PDDC of IC bm_comprising a_ntwk. The illustration shows: in FIG. 19 an enhanced and/or new wireline phone connected to a standalone plug-and-play “image content” display device, with means comprising a wireline communication link; in FIG. 20 an enhanced and/or new wireless handheld consisting an integrated “image content” display device thereon; in FIG. 21 an enhanced and/or new mobile phone, and in FIG. 22 an enhanced and/or new wireless handheld computer, consisting an integrated “image content” display device thereon, where all of the preceding said for PDDC of IC bm_comprising a_ntwk. The illustration in FIGS. 21, and 22, respectively show, comprising additionally, a wireline, wireless, and/or network communication link to a standalone, and a standalone multi-terminal, “image content” display device for PDDC of IC bm_comprising a_ntwk.

FIGS. 17 thru 22 illustrate PDDC of “image content”, with means comprising a SS, bm_comprising a_ntwk. The said figures, excluding FIG. 19, also show an enhanced and/or new system, process, procedure, product, and/or product-by-process, for PDDC of “image content”, comprising a standalone plug-and-play and/or an integrated “image content” display device, for PDDC of IC bm_comprising a_ntwk, while FIG. 19 shows an enhanced and/or new system, process, procedure, product, and/or product-by-process, for PDDC of ‘moving picture’ with means of an online and/or network computer bm_of_a_ntwk.

A standalone and/or integrated, portable or mobile, integrated multi-terminal and/or multi-terminal integrated display device in FIG. 22, shows a segmented and/or partitioned display terminal and/or panel, for PDDC of IC bm_comprising a_ntwk. The utility of a said enhanced, new, and/or converged, portable or mobile electronic display device, is for PDDC comprising multiple, simultaneously input “image content”, comprising from more than one performing source. A said display device, for a standalone, independent, and/or converged PASPSSC, comprises being employed for PDDC of IC bm_comprising a_ntwk. The said figure, also shows a wireless handheld computer, namely a PDA, connecting to a said multi-terminal display device with means of a wireline, wireless, and/or network communication link.

The enhanced and/or new internet-phone′ in FIG. 18 is employed for PDDC of IC bm_of_a_ntwk, whereas, an enhanced and/or new wireline phone, wireless handheld, and mobile phone, respectively in FIGS. 19, 20, and 21, and an enhanced and/or new wireless handheld computer in FIG. 22, are employed for PDDC of IC bm_comprising a_ntwk.

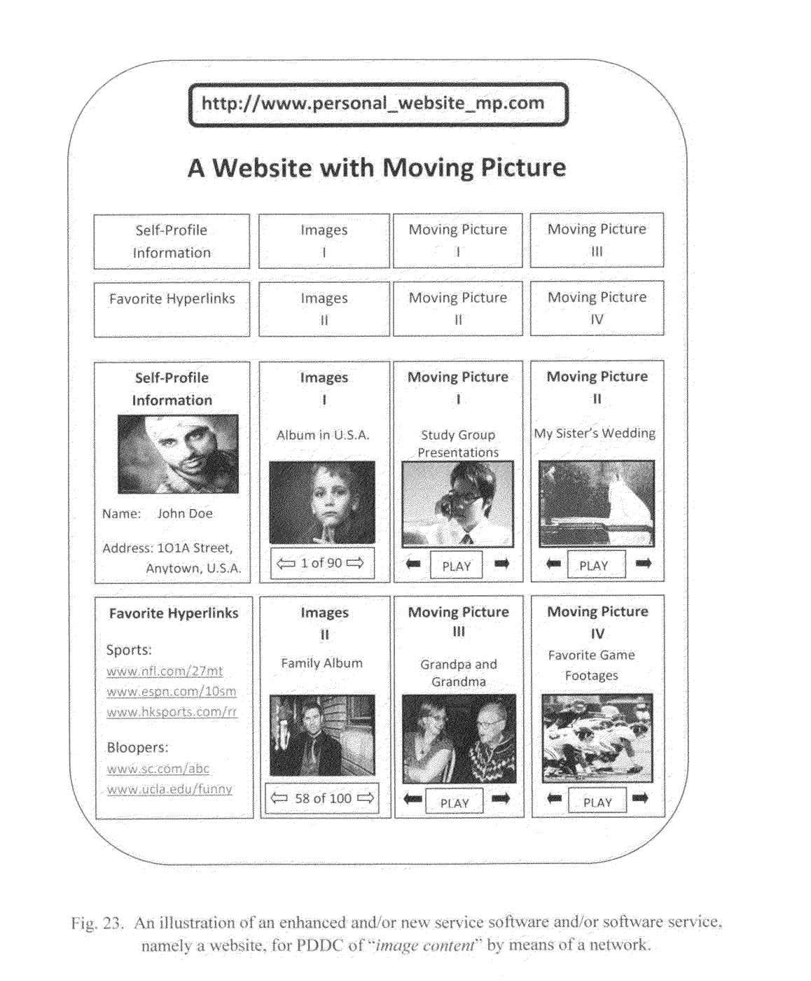

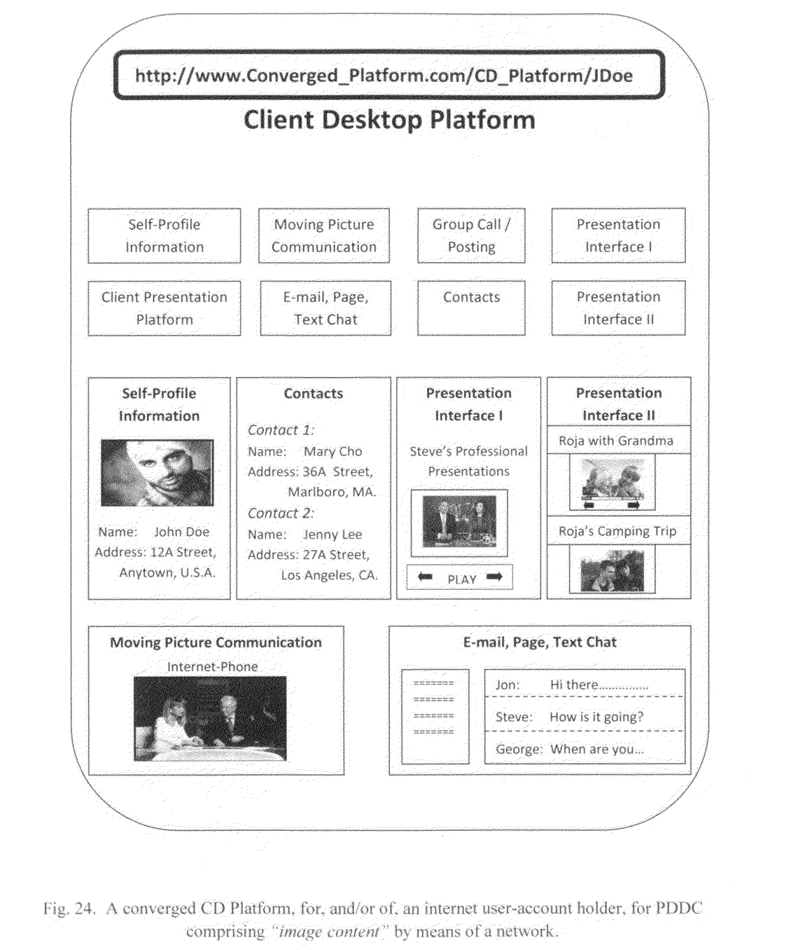

FIG. 23 illustrates an enhanced and/or new SS, namely a website, for PDDC of IC bm_of_a_ntwk. The said illustration shows a website, webpage, a series and/or multiples thereof, for PDDC of ‘moving picture’, comprising user controls for interactivity, bm_of_a_ntwk.

FIG. 24 illustrates a Converged Platform, namely a CD Platform, for, and/or of, an IUA holder, for converged communication and web presenting. The said figure shows a converged communication and web presenting SS, comprising a CNS, PNS, and/or NS, for PDDC comprising IC bm_of_a_ntwk. The said figure also shows a NIIC, NISC, and/or NIPC user-account and/or IUA holder CD Platform, comprising a NIC ‘internet-phone’ for PDDC comprising IC bm_of_a_ntwk.

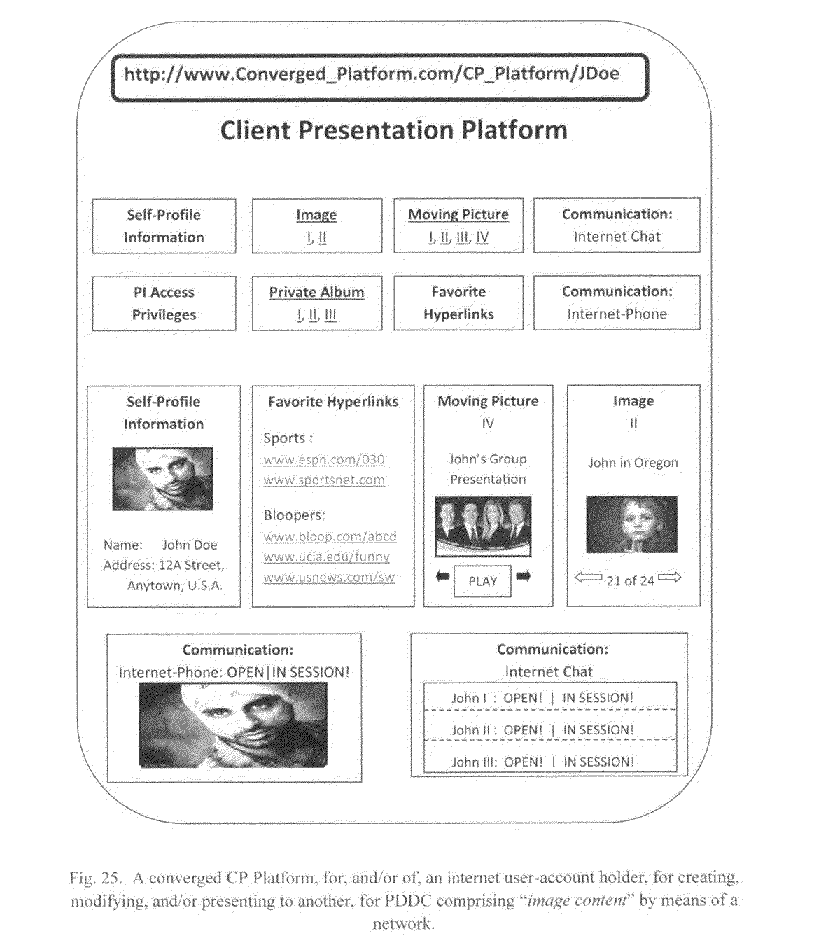

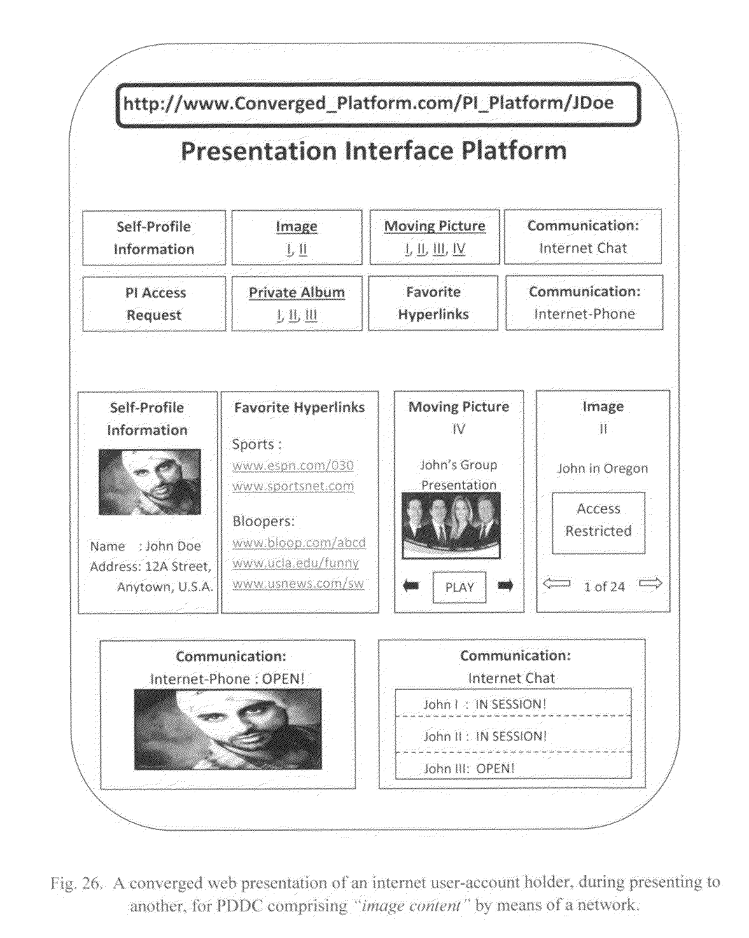

FIG. 25 illustrates a Converged Platform, namely a CP Platform, for, and/or of, an IUA holder, for converged web presenting and communication. The said figure shows a web presenting PASPSSC, comprising a website template, webpage template, a series and/or multiples thereof (“web template”), for creating, modifying, and/or presenting to another, of a web presentation for PDDC comprising IC bm_of_a_ntwk. A NIIC, NISC, and/or NIPC user-account and/or IUA holder, creates a said website and/or webpage, with means comprising inputting, fusing, and/or integrating of “image content”, IM_COMB, and/or a communication PASPSSC for communication with the web presenter, into and/or onto a said web presenting PASPSSC, for presenting to another for PDDC comprising IC bm_of_a_ntwk.

To clarify, the enhancement presented a NIIC, NISC, and/or NIPC user-account and/or IUA holder, comprises a converged service platform and/or platform service, for communication, communication and web presenting, web presenting, and/or web presenting and communication, abbreviated herein as C_CWP_WP_and/or_WPC. A said Converged Platform, with means of a user-account and/or an IUA, comprises, (1) more than one communication PASPSSC, for convergence in communication, (2) a communication PASPSSC, and a web presenting PASPSSC comprising a web template, for convergence in communication and web presenting, (3) a web presenting PASPSSC comprising web templates, for creating a web presentation with “image content” and/or IM_COMB, for convergence in web presenting, and/or (4) a web presenting and communication PASPSSC comprising web templates, for creating a web presentation with “image content”, IM_COMB, and/or a communication PASPSSC, for convergence in web presenting and communication. A said Converged Platform CNS, PNS, and/or NS, is an enhancement over prior-art, comprising for convergence in C_CWP_WP_and/or_WPC, for PDDC comprising IC bm_of_a_ntwk. The aforesaid advancement of, and/or for, a converged SS, enhances a USER's visual and/or audio-visual perception of events during a said PDDC bm_of_a_ntwk, comprising resultant enhancements in character, functionality, capability, and/or properties thereof.

At the time of invention, the drawback of a CNS, PNS, and/or NS, was that a said, comprising with means of a user-account and/or an IUA, was not on a fused, integrated, and/or Converged Platform. The said incapability leaves a USER unorganized, in that, access to, and/or use of, each of a said SS comprises an independent and/or separate act, process, and/or procedure, in contrast to being coordinated and/or converged. Further, the maintaining and/or servicing of an independent and/or separate communication software, service, and/or device, is cost ineffective to a USER. To overcome said shortcomings, a segment of this invention presents an enhanced and/or new fused, integrated, and/or converged SS platform, for C_CWP_WP_and/or_WPC, for PDDC comprising IC bm_of_a_ntwk.

It is well settled, that, when elements constituting network PDDC to, and/or from, a USER comprises semi-fused and/or semi-integrated elements of IM_COMB, the subjective quality of the resultant communication is compromised. Similarly, it is established that, when a SS is stand-alone or independent, a said software and/or service is limited to its' character, functionality, capability, and/or properties. In contrasting thereto, a fused, integrated, and/or converged SS, comprises inheriting the character, functionality, capability, and/or properties, of a said fused, integrated, and/or converged PASPSSC, on a said converged CNS, PNS, and/or NS, for PDDC comprising IC bm_of_a_ntwk.

To mitigate the shortcomings of a stand-alone or independent SS, the invention presents for Network Integrated Communication (“NIC”), a fused, integrated, and/or converged SS platform, comprising a Converged Platform with means of a user-account and/or an IUA, for PDDC comprising IC bm_of_a_ntwk. A said enhancement comprises presenting to a USER, an organized, cost effective, and/or a converged solution for C_CWP_WP_and/or_WPC, for PDDC comprising IC bm_of_a_ntwk.

1. An Enhanced and/or New SS

The specification going forward, presents enhancements constituting a SS, comprising a CNS, PNS, and/or NS, in this paragraph. An enhancement of, and/or for, a SS, comprises, (a) inputting, fusing, and/or integrating of “image content” thereinto, for PDDC comprising IC bm_of_a_ntwk; and/or (b) presenting a Converged Platform to a USER, comprising with means of a user-account and/or an IUA, for inputting, fusing, and/or integrating of “image content” thereinto, for PDDC comprising IC bm_of_a_ntwk.

An enhancement of, and/or for, a SS for PDDC comprising IC bm_of_a_ntwk, is described herein with an example of, an e-mail SS comprising an e-mail message. An enhancement on any SS is similar to, and/or a variation of, the said described example within scope of this invention.

The first described enhancement, in paragraph 1 {a} herein-below, presents a SS, for PDDC comprising IC bm_of_a_ntwk. Prior-art relating to the said, comprises a SS, for PDDC of COMB bm_of_a_ntwk.

The second described enhancement, in paragraph 1 {b} herein-below, presents a Converged Platform, with means of a user-account and/or an IUA, for inputting, fusing, and/or integrating of “image content”, IM_COMB, and/or a communication PASPSSC, for PDDC comprising IC bm_of_a_ntwk. Prior-art relating to the said, comprises a SS platform that is stand-alone, independent, and/or limitedly converged, for PDDC of, COMB during web presenting, and/or text and/or audio during communication, by means of a computer network. An example of a said limitedly converged SS platform, comprises, an online and/or network interactive computer desktop platform, a wireless handheld computer platform, a user-account and/or an IUA platform, and/or the like, for PDDC of COMB by means of a computer network. A limitedly converged phone platform, comprises, a wireless handheld hybrid platform for PDDC of text and/or audio bm_of_a_ntwk; and a wireline phone, wireless handheld, and/or mobile phone platform for PDDC of audio and/or limited text bm_of_a_ntwk. A limitedly converged communication PASPSSC, comprises, an internet chat, instant messaging, and/or internet-phone′ SS for PDDC of text, audio, and/or voice bm_of_a_ntwk. The enhancements on all of the said, for PDDC comprising IC bm_of_a_ntwk, comprises being encompassed in paragraph 1 {a} herein following.

A presenting of a said enhanced and/or new system, process, procedure, product, and/or product-by-process, of, and/or for, a SS, requires advancements comprising in hardware, software, and/or embedded systems, comprising networking hardware, for enabling and/or facilitating of PDDC of ‘moving picture’ and/or “image content” bm_of_a_ntwk.

System, Process, and/or Means for Capturing and/or Communication of Events for PDDC:

A system, process, procedure, product, and/or product-by-process, for PDDC of IC bm_of_a_ntwk, is facilitated with means comprising employing of a moving picture comprising an image camera, for capturing visual and/or audio-visual elements of an event, and thereupon communicating a said event for pre-processing with means comprising a hardware, software, and/or embedded system. A said pre-processed event data, is thereupon communicated to a PASPSSC for further processing and/or PDDC bm_comprising a_ntwk.

A said system, process, and/or means, enables and/or facilitates captured “image content” of an event, for PDDC comprising on a USER's performance displaying (“PD”) device, bm_comprising a_ntwk. A said captured comprising self-tested elements of an event, comprise being real-time and/or asynchronously communicated to a device, service software, software service, and/or a combination thereof, comprising for a one-, two-, and/or multi-way PDDC of IC bm_of_a_ntwk.

1 {a}. An Enhanced and/or New SS for PDDC of “Image Content”

As at the time of invention, limited “image content”, specifically static images, were presented for PDDC with means of a SS, comprising a website and/or webpage, by means of a computer network. A segment of this invention, presents an enhanced and/or new SS, for PDDC of, ‘moving picture’ by means of a computer network, and/or “image content” by means of a phone and/or hybrid network, both of said an enhancement over prior-art. Another segment of this invention, presents an enhanced and/or new ‘internet-phone’, for PDDC of ‘moving picture’, image, and/or associated audio if any, bm_of_a_ntwk, an enhancement over prior-art comprising a SS relating thereto. A further segment of this invention, presents an enhanced and/or new wireline phone, wireless handheld, and/or mobile phone, for PDDC of IC bm_comprising a_ntwk, an enhancement over prior-art comprising a SS relating thereto. A further segment of this invention is an enhanced and/or new converged SS, for, (1) inputting, fusing, and/or integrating of, ‘moving picture’ for PDDC by means of a computer network, and/or “image content” by means of a phone and/or hybrid network; and/or (2) inputting, fusing, and/or integrating of a communication and/or web presenting PASPSSC, for convergence in communication, communication and web presenting, web presenting, and/or web presenting and communication, with means of a Converged Platform, means comprising a user-account and/or an IUA, for PDDC comprising IC bm_of_a_ntwk.

The specification describes, by example, an enhancement of an e-mail SS, comprising an e-mail message, that forms a basis and/or variation for enhancement of a SS for PDDC of IC bm_of_a_ntwk.

A USER is presented an e-mail SS, for communication of an e-mail message comprising elements of text, hyperlink, and/or a file attachment. A said USER, initiates a received e-mail message for PDDC bm_of_a_ntwk, for reading, replying, printing, saving, deleting, and/or the like. If a received e-mail message consists an attached file, the said file comprises being downloaded to a said USER platform, for executing with means of said attached file application software, independent or separate from the said e-mail SS.

The drawback of the said, is that a said e-mail SS, by itself, cannot enable and/or facilitate a said attached file for PDDC bm_of_a_ntwk, nor for interactive PDDC bm_of_a_ntwk, without the requirement to port a said attached file away from said e-mail SS. An enhancement described herein, presents a said attached file for PDDC of IM_COMB bm_of_a_ntwk, from within said e-mail SS, without requiring to port the said attached file away therefrom. A said system, process, procedure, product, and/or product-by-process, avoids the required process and/or procedure of porting a said attached file away from said e-mail SS for PDDC of IM_COMB bm_of_a_ntwk, while mitigating shortcomings of the said attached file application software, comprising deficiencies in a USER platform.

The enhancement of, and/or for, an e-mail SS, for a said e-mail message attached file PDDC comprising IC bm_of_a_ntwk, is enabled and/or facilitated with means of presenting the said attached file, comprising, a link to the said attached file application software, and/or a means for obtaining the said application software from the USER platform, a web server, or the e-mail SS receiving or originating said e-mail message. An alternative to the aforesaid, comprises embedding an executable version of the attached file application software to the said attached file. The aforesaid enables an e-mail message attached file, for PDDC comprising IC bm_of_a_ntwk, without requiring to port a said attached file away from said e-mail SS.

The said enhancement presents to a USER, an enhanced and/or new SS, for PDDC of “image content” in a server and/or host, with means comprising a web browser, bm_of_a_ntwk. A said enhancement presents a subjective, objective, and ergonomic SS for PDDC of IC bm_of_a_ntwk, whereof presenting for efficient visual and/or audio-visual perception of the subject and/or object information bm_of_a_ntwk.

An enhancement of, and/or for, any SS for PDDC of IC bm_of_a_ntwk, is similar to, and/or a variation of, a said enhancement of, and/or for, an e-mail SS for PDDC of IC bm_of_a_ntwk.

1{b}. An Enhanced and/or New SS for a Converged Platform

Another enhancement upon this invention, is presenting for Network Integrated Communication, referred to as “NIC”, a converged SS platform (“Converged Platform”), comprising for converged communication, communication and web presenting, web presenting, and/or web presenting and communication, for PDDC comprising IC bm_of_a_ntwk. A said Converged Platform, is presented to a USER, with means comprising a user-account and/or an IUA bm_of_a_ntwk, an enhancement over prior-art.

A said Converged Platform with means of a user-account and/or an IUA, comprises of, and/or for, inputting, fusing, and/or integrating, of, (1) more than one communication PASPSSC for a converged communication platform with means of a user-account login, (2) a communication PASPSSC, and a web presenting PASPSSC comprising a web template, of, and/or for, “image content” and/or IM_COMB, for a converged communication and web presenting platform, (3) a web presenting PASPSSC comprising a web template, of, and/or for, “image content” and/or IM_COMB, for a converged web presenting platform, and/or (4) a web presenting PASPSSC comprising a web template, of, and/or for, “image content”, IM_COMB, and a communication PASPSSC for real-time comprising asynchronous communication with the web presenter, for a converged web presenting and communication platform; all of said converged SS for PDDC comprising IC bm_of_a_ntwk.

A said inputting, fusing, and/or integrating, enhances the character, functionality, capability, and/or properties, of, and/or for, a said Converged Platform for C_CWP_WP_and/or_WPC, comprising inheriting characteristics from a said inputted, fused, and/or integrated “image content”, IM_COMB, and/or communication PASPSSC.

A Converged Platform comprises being presented with means of a user-account and/or an IUA. A Converged Platform with means of a user-account and/or an IUA, comprises a software platform, platform software, service platform, and/or platform service, similar to an e-mail SS platform, comprising in account set-up and/or usage. A said Converged Platform, comprises a combination of, a communication and/or web presenting PASPSSC, for “image content” and/or IM_COMB, for PDDC comprising asynchronous and/or real-time IC bm_of_a_ntwk.

A said Converged Platform, is an enhancement over prior-art, in that it presents a Converged Platform, with convergence of more than one communication PASPSSC with means of a user-account login, comprising an e-mail, internet chat, ‘internet-phone’, pager, web browser, and/or a like SS, for PDDC comprising IC bm_of_a_ntwk. Another of a Converged Platform, presents for converged communication and web presenting, web presenting, or web presenting and communication, a said web presenting with means comprising a web template, comprising of “image content” and/or IM_COMB. The said Converged Platforms are described in section 4 of this specification herein below.

An enhancement of a said Converged Platform, comprises presenting to a user-account and/or an IUA holder, a customizable platform for C_CWP_WP_and/or_WPC, comprising for, and/or of, inputting, fusing, integrating, and/or porting, a communication and/or a web presenting PASPSSECC, for PDDC comprising IC bm_of_a_ntwk.

FIGS. 24, and 25, illustrate a Converged Platform, for, and/or of, an IUA holder. A said Converged Platform, comprises being utilized by the said IUA holder, on a USER environment comprising a desktop, for self-usage comprising: a one-, two-, and/or multi-way communication and/or a web presenting with means thereof; creating, modifying, and/or presenting to another, of a web presenting with mean comprising a web template, comprising “image content”, IM_COMB, and/or a communication PASPSSC for real-time comprising asynchronous communication with the web presenter; and/or for communication, web presenting, web viewing, and/or browsing; for PDDC comprising IC bm_of_a_ntwk.

A Converged Platform, for, and/or of, an IUA holder, namely a CD Platform, for self-usage in converged communication and web presenting, for PDDC comprising IC bm_of_a_ntwk, is illustrated in FIG. 24. Another of a Converged Platform, for, and/or of, an IUA holder, namely a CP Platform, for self-usage in converged web presenting and communication, for PDDC comprising IC bm_of_a_ntwk, is illustrated in FIG. 25.

A client-server for NIC, for PDDC comprising IC bm_of_a_ntwk, is illustrated in FIG. 17. The said illustration consisting of ‘host data’ presents a client-server for NIIC, whereas a said consisting of ‘user data’, comprises presenting a client-server for NISC and/or NIPC. A NIPC additionally comprises requiring of an entity authorization, for creating, accessing, and/or using of a NIPC user-account comprising a said client-server. The contrast in illustration of a NIC client-server for NIIC, to that of a NIC client-server for NISC and/or NIPC, comprising as illustrated in FIG. 17, is that the latter consists “image content” and/or IM_COMB, of, and/or for, a user-account and/or an IUA holder thereon, and/or a place-holder therefor, for PDDC comprising IC bm_of_a_ntwk.

A USER gains access to, and/or using of, NIIC, NISC, and/or NIPC, with means comprising a SS, comprising a Converged Platform, for PDDC comprising IC bm_of_a_ntwk. A said Converged Platform, comprises being presented with means of a user-account and/or an IUA, comprising a said account holder DI Platform, CD Platform, WP Platform, CP Platform, and/or PI Platform, for PDDC comprising IC bm_of_a_ntwk.

A USER gains access to, and/or using of, a user-account based NIIC, NISC, and/or NIPC, on setting up of a said user-account and/or logging thereinto. A said user-account holder, comprises being presented a Converged Platform comprising a service software, software service, and/or other resources, with means of a client-server and/or host. A said client-server and/or host, additionally consists said user-account holder specific data, comprising server space, bandwidth, “image content”, IM_COMB, and/or the like. Further resources presented said user-account holder, comprises, subscription-less or subscription-based software and/or service packages, for PDDC comprising IC bm_of_a_ntwk.

A said user-account holder, selects, places, arranges, and/or manipulates, an existing, enhanced, and/or new, PASPSSC of interest to the said user-account holder, on a DI Platform, CD Platform, WP Platform, and/or CP Platform.

A DI Platform, and CD Platform, comprise being employed for NIIC, NISC, and/or NIPC, by the said user-account holder, for self-use comprising for: a one, two, and/or multi-way communication; for creating, modifying, and/or presenting to another, of a web presentation; and/or for web viewing and/or browsing; for PDDC comprising IC bm_of_a_ntwk. An illustration of a said user-account holder CD Platform, for PDDC comprising IC bm_of_a_ntwk, is shown in FIG. 24.

Similarly, a WP Platform, and a CP Platform, comprise being employed for NIIC, NISC, and/or NIPC, by the said user-account holder, for self-use comprising for: creating, modifying, and/or presenting to another, of a web presentation comprising “image content”, IM_COMB, and/or a communication PASPSSC, for PDDC comprising IC bm_of_a_ntwk. A said web presentation, comprises being created with means of a web template, comprising a self-profile, other information, “image content”, IM_COMB, and/or communication PASPSSC. An illustration of a said user-account holder CP Platform, for PDDC comprising IC bm_of_a_ntwk, is shown in FIG. 25.

A said user-account holder, presents a DI Platform, CD Platform, WP Platform, and/or CP Platform, comprising as a web presentation to another, with means comprising a website, webpage, and/or PI Platform, comprising privileges for accessing, using, and/or browsing, for PDDC comprising IC bm_of_a_ntwk.

A said web presenting with means of a website, webpage, and/or PI Platform, means comprising a DI Platform, CD Platform, WP Platform, and/or CP Platform, comprises automation and/or automated customization, of “privileges” comprising a permission and/or restriction, for accessing, using, and/or browsing, at the time of presenting to another. A said automation and/or automated customization, with means comprising control settings on a said DI Platform, CD Platform, WP Platform, CP Platform, and/or PI Platform, of the presenter and/or administrator, is adaptive comprising on the profile and/or information of the another seeking accessing, using, and/or browsing, of a said presentation; and/or adaptable on the request of the said another accessing, using, and/or browsing, of a said presentation. A said user-account holder CP Platform illustrated in FIG. 25, is shown in FIG. 26 during a web presenting to another, comprising automation and/or automated customization, for PDDC comprising IC bm_of_a_ntwk.

2. An Enhanced and/or New Phone and/or a SS Therefor
An Active and/or Passive Participant During a Call Session:

An active participant is a USER, who participates actively during a call session. In contrasting thereto, a passive participant is a USER, who does not actively participate, but instead participates passively as an observer, during a call session.

A one-, two-, and/or multi-way call session, with means of an ‘internet-phone’, wireline phone, wireless handheld, and/or mobile phone, means comprising a SS, comprises of active, passive, and/or other participants. A said product, service software, software service, and/or device, transmits for and/or during a call session, “image content” and/or IM_COMB of an active participant, to other active participants for PDDC bm_of_a_ntwk. A said product, service software, software service, and/or device, comprises an option, for transmitting for and/or during a call session, “image content” and/or IM_COMB of a passive and/or other participant, to active participants for PDDC bm_of_a_ntwk. The system, process, and/or procedure, for PDDC to a passive and/or other participant of IC bm_of_a_ntwk, are similar to that for PDDC to an active participant of IC bm_of_a_ntwk, as stated hereinbefore.

### a Multi-Party Call Session:

A multi-party call session, with means of an ‘internet-phone’, wireline phone, wireless handheld, and/or mobile phone, means comprising a SS, comprises of active, passive, and/or other participants. A said multi-party call session, comprises participants connecting to a said call session bm_of_a_ntwk. The system, process, procedure, product, product-by-process, and/or means, of a multi-party call session of this invention, transmits and/or receives visual and/or audio-visual elements, of, and/or from, a participant, for PDDC comprising IC bm_of_a_ntwk.

A said system, process, procedure, and/or product, comprises participants joining, and/or leaving, a call session. An aforesaid facilitates a participant, for joining a multi-way call session with means comprising a request, and authorizing. A said authorizing is granted comprising by the administrator, a participant, and/or the USER setting-up, of a said call session.

A said system, process, procedure, and/or product, comprises adding a call session joining participant's, and/or dropping a call session leaving participant's, visual and/or audio-visual elements, respectively for, and from, a call session PDDC bm_of_a_ntwk.

A said call session, comprises with means of a system, process, procedure, product, product-by-process, and/or service, with means of an ‘internet-phone’, wireline phone, wireless handheld, and/or mobile phone, by means of a network.

2{a}. An ‘Internet-Phone’ for PDDC of “Image Content”

As at the time of invention, a phone with means of an online and/or network computer, was presented with means of a SS comprising a PASPSSC (′internet-phone′ SS), by means of a network. A said ‘internet-phone’, comprised communication of audio and/or limited text, by means of a user initiated call-request to a destination identifier, and the said call-acceptance by the said destination identifier (“UICRA”), comprising a call receiving party and/or message service; a system, process, and/or procedure, similar to a dial-up phone connecting to a call receiving party and/or message service. An ‘internet-phone’ USER comprising a calling party, establishes a communication link with the call receiving party and/or message service, with means comprising the prior-art of an ‘internet-phone’ call setting-up system, process, and/or procedure.

An enhanced and/or new ‘internet-phone’ of this invention, presents for a one-, two-, and/or multi-way PDDC of real-time and/or asynchronous IC bm_of_a_ntwk, an enhancement over a prior-art ‘internet-phone’ that presented for PDDC of audio and/or limited text.

An enhanced and/or new ‘internet-phone’, for PDDC of visual and/or audio-visual IC bm_of_a_ntwk, is illustrated in FIG. 18. A said ‘internet-phone’ PDDC of “image content” and/or IM_COMB comprising a calling party, call receiving party, active participant, passive participant, and/or other participant, presents an enhanced and/or new ‘internet phone’ for PDDC comprising IC bm_of_a_ntwk.

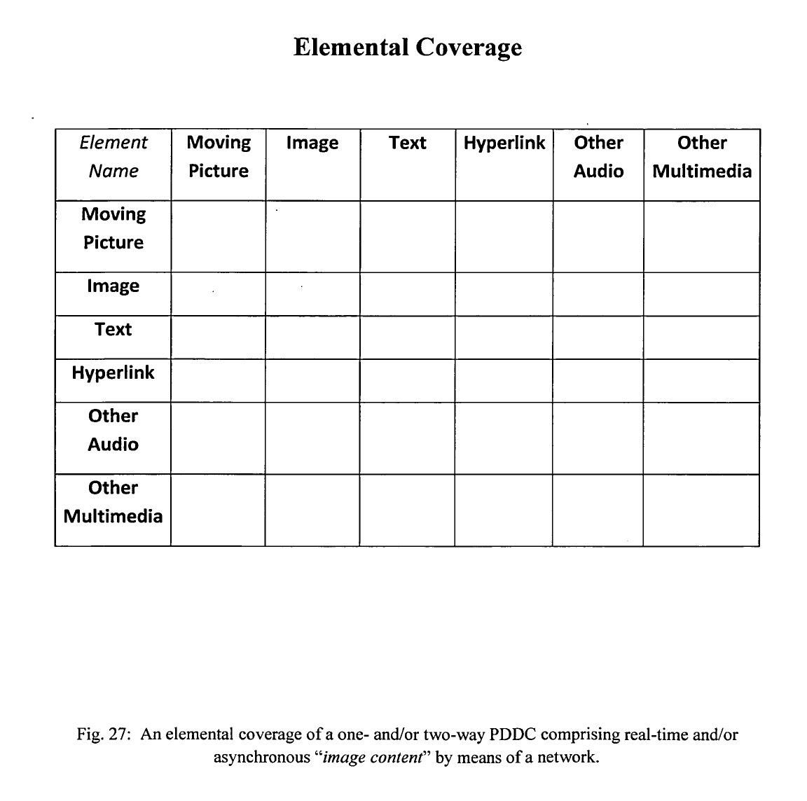

An enhanced and/or new internet-phone′, comprises facilitating a one-, two-, and/or multi-way PDDC of “image content” and/or IM_COMB, by means of a network. A said multi-way PDDC comprises originating, when a USER actively and/or passively participates during an internet-phone′ call session consisting two participants. The elemental coverage of a one- and/or two-way PDDC comprising IC bm_of_a_ntwk, with means of an enhanced and/or new ‘internet-phone’, comprises as illustrated in FIG. 27. The said table of coverage, is extensible for a said ‘internet-phone’ communication consisting a multi-way PDDC comprising IC bm_of_a_ntwk.

The system, process, procedure, product, product-by-process, and/or means, for capturing, communicating, inputting, self-testing, and/or transmitting of “image content” for PDDC bm_comprising a_ntwk, are as described in paragraph 2 hereinbefore. A said captured event, comprising “image content” and/or IM_COMB, comprises being real-time and/or asynchronously input into an enhanced and/or new ‘internet-phone’, for a one-, two-, and/or multi-way PDDC of real-time and/or asynchronous IC bm_of_a_ntwk.

C. Specification—“Prior Application Specification”: Begin

2{b}. A Wireline Phone for PDDC of “Image Content”

As at the time of invention, the primary phone in worldwide phone usage was a wireline phone, by means of a wireline phone network. The prior-art in wireline phone communication, comprised PDDC of audio and/or limited text, by means of a wireline phone network.

A segment of this invention, presents an enhanced and/or new wireline phone for PDDC of IC bm_comprising a_ntwk, an enhancement over prior-art. The aforesaid, is enabled and/or facilitated with means of a plug-and-play, attached, and/or integrated, “image content” capturing and/or displaying device. A said enhanced and/or new wireline phone system, process, procedure, product, product-by-process, and/or means, enables and/or facilitates for PDDC of IC bm_comprising a_ntwk.

FIG. 19 illustrates an enhanced and/or new wireline phone, for PDDC of “image content” with means of a display device connected to said phone bm_comprising a_ntwk. A said display device may alternatively be attached to, and/or integrated on, a said enhanced and/or new wireline phone, for PDDC of IC bm_comprising a_ntwk.

An image and/or moving picture camera, captures “image content” of an event, and communicates the said for pre-processing, self-testing, and/or PDDC bm_comprising a_ntwk. The system, process, procedure, product, product-by-process, and/or means, for capturing, communicating, inputting, self-testing, and/or transmitting of “image content” for PDDC with means of a wireline phone bm_comprising a_ntwk, are similar to that as described in paragraph 2 and/or 2{a} hereinbefore.

An enhanced and/or new wireline phone, comprises facilitating a one-, two-, and/or multi-way PDDC of “image content” and/or IM_COMB bm_comprising a_ntwk. A said multi-way PDDC comprises originating, when a USER actively and/or passively participates during a wireline phone call session consisting two participants. The elemental coverage of a one- and/or two-way PDDC comprising IC bm_of_a_ntwk, with means of an enhanced and/or new wireline phone, comprises as illustrated in FIG. 27. The said table of coverage, is extensible for a said wireline phone communication consisting a multi-way PDDC comprising IC bm_of_a_ntwk.

An enhanced and/or new wireline phone, upon this invention, comprises PDDC of real-time and/or asynchronous IC bm_comprising a_ntwk. Another enhancement is hybrid communication of “image content” and/or IM_COMB, with means comprising a SS, to and/or from: an online, wireless handheld, and/or network computer; and/or a wireline phone, wireless handheld, and/or mobile phone; whereof facilitating for PDDC of IC to, and/or from, an enhanced and/or new wireline phone bm_of_a_ntwk.

2{c}. A Wireless Handheld and/or a Mobile Phone for PDDC of “Image Content”

At the time of invention, the prior-art in wireless phone, wireless handheld, and/or mobile phone communication, comprised PDDC of audio and/or limited text, by means of a phone network.

A segment of this invention, presents an enhanced and/or new wireless phone, wireless handheld, and/or mobile phone, for PDDC of IC bm_comprising a_ntwk, an enhancement over prior-art. The aforesaid, is enabled and/or facilitated with means of a plug-and-play, attached, and/or integrated, “image content” capturing and/or displaying device. A said enhanced and/or new wireless phone, wireless handheld, and/or mobile phone system, process, procedure, product, product-by-process, and/or means, enables and/or facilitates for PDDC of IC bm_comprising a_ntwk.

A wireless handheld and/or mobile phone communication, comprising a wireless phone, wireless handheld, and/or mobile phone, is facilitated with means of a wireless communication channel, comprising an intermediate or wholly wireless channel. A said communication, comprises an enhanced and/or new wireless phone, wireless handheld, and/or mobile phone, for PDDC of IC bm_comprising a_ntwk.

A said enhanced and/or new device, upon this invention, presents for visual and/or audio-visual PDDC of IC bm_comprising a_ntwk. The system, process, and/or procedure, for initiating, (1) a wireless network communication link with means of a wireless phone, wireless handheld, and/or mobile phone, is similar to a computer establishing a communication link to a wireless computer network; and (2) a mobile network communication link with means of a wireless phone, wireless handheld, and/or mobile phone, is similar to a prior-art mobile phone establishing a communication link to a mobile network. The system, process, procedure, product, and/or product-by-process, for initiating a call session, with means of a wireless phone, wireless handheld, and/or mobile phone device, is similar to that of initiating a call session with means of an ‘internet-phone’ and/or wireline phone described respectively in paragraph 2{a}, and 2{b}, hereinbefore.

FIGS. 20, 21, and 22, respectively illustrate an enhanced and/or new wireless handheld, mobile phone, and a wireless handheld computer, for PDDC of visual and/or audio-visual IC bm_comprising a_ntwk. The said figures show a said device, comprising an integrated image and/or moving picture camera for capturing events for PDDC of IC bm_comprising a_ntwk. A said wireless handheld, mobile phone, and/or wireless handheld computer, may alternatively, or concurrently, be connected to an external image and/or moving picture camera, and/or an external visual and/or audio-visual displaying device, by means of a wireline, wireless, and/or network communication link.

An image and/or moving picture camera, captures “image content” of an event, and communicates the said for pre-processing, self-testing, and/or PDDC bm_comprising a_ntwk. The system, process, procedure, product, product-by-process, and/or means, for capturing, communicating, inputting, self-testing, and/or transmitting of “image content” for PDDC with means of a wireless phone, wireless handheld, mobile phone, and/or wireless handheld computer, bm_comprising a_ntwk, are similar to that as described in paragraph 2, 2{a}, and/or 2{b}, hereinbefore.

A wireless handheld computer, comprising a PDA, comprises being used as a mobile phone, while a mobile phone device comprises being used as a wireless handheld computer. A said enhanced and/or new device, comprising a hybrid computer and/or phone, is encompassed herein, as a wireless handheld or mobile phone, for a combination of either and/or both of said, for PDDC of IC bm_comprising a_ntwk.

2{d}. A Hybrid Communication of “Image Content”

The invention presents enhancements on a SS, for PDDC of “image content” by means comprising a hybrid network. A said enhanced and/or new SS, possesses capability for cross-network PDDC of “image content” by means comprising a hybrid network. The paragraph herein proceeding, describes the system, process, procedure, product, and/or product-by-process, for hybrid communication, comprising requirements relating thereto.

A hybrid communication system, process, procedure, product, and/or product-by-process, presents to a USER, comprising device and/or network related content-constraints, a SS for PDDC of “image content” by means comprising a hybrid network. A said enhancement, enables a wireline phone, wireless handheld, and/or mobile phone, for accessing and/or using of a CNS and/or NS, and/or a computer for accessing and/or using of a PNS and/or NS, by means comprising a hybrid network; where a said hybrid network, comprises a computer-phone and/or phone-computer network, referred to herein respectively, as a “hybrid computer-phone network”, and a “hybrid phone-computer network”; either of the said being generally referred to as a “hybrid network”.

A hybrid network PDDC of “image content”, is similar to, an independent computer or phone network PDDC of “image content”, consisting the capability for additionally communicating “image content” and/or IM_COMB from a computer to a phone, and/or vice versa, from a phone to a computer.

However, the drawback is that all capabilities cannot be presented to a USER, with means of a display and/or resource constrained wireline phone, wireless handheld, and/or mobile phone, comprising power constraints thereof, for PDDC of asynchronous and/or real-time IC bm_of_a_ntwk. Henceforth, a limited description of hybrid communication, between a computer and phone, for PDDC of IC bm_of_a_ntwk is presented herein-following.

A said enhancement presents for a computer, wireline phone, wireless handheld, and/or mobile phone, for accessing and/or using of a NIC resource, comprising a CNS, PNS, and/or NS, for PDDC of “image content” by means comprising a hybrid network. The aforesaid is an enhancement in a computer and/or phone device-specific, cross-network PDDC of “image content” with means of a service software, software service, and/or hybrid network.

A said hybrid communication, comprises an online, wireless handheld, and/or network computer, server, and/or host, cross-communicating with a wireline phone, wireless handheld, and/or mobile phone device, software, and/or service; and/or vice versa, a wireline phone, wireless handheld, and/or mobile phone, server, and/or host, cross-communicating with an online, wireless handheld, and/or network computer device, software, and/or service; a said cross communication by means comprising a hybrid network.

A said hybrid PDDC of IC bm_of_a_ntwk, is enabled and/or facilitated with means of a device, network hardware, service software, and/or software service, for hybrid access, use, and/or network communication.

A said hybrid access, use, and/or network communication, comprising a wireline and/or wireless network, on enabling communication comprising, between, a computer and phone device, a computer and a PNS or NS, a phone and a CNS or NS, and/or a computer network and a phone network, makes a SS cross network compatible for access, use, and/or cross-network communication, for PDDC of IC bm_of_a_ntwk.

The enhancements on a SS, for PDDC of “image content” by means comprising a hybrid network, comprises: “image content” on a SS for hybrid access, use, and/or network communication; and/or presenting an existing, enhanced, and/or new CNS and/or PNS, comprising NS transformability for, and/or during, communication, for PDDC of “image content” by means comprising a hybrid network.

A SS provider whereof presents of, and/or for, and a USER whereby gains access, using, and/or network communication of, a SS for PDDC of “image content” by means comprising a hybrid network. A said enhancement presents a resourceful, scalable, and/or robust means, for visual and/or audio-visual perception of real-time and/or asynchronous events by means comprising a hybrid network.

C. Specification “Prior Application Specification”: End
C. Specification—“Prior Application Specification”: Begin
   2{e}. A Multi-Terminal Display Device for PDDC of “Image Content”

A portable and/or mobile; standalone, system- and/or device-integrated; multi-terminal integrated and/or integrated multi-terminal electronic display device, for visual and/or audio-visual PDDC of IC bm_comprising a_ntwk, is illustrated in FIG. 22. The said figure shows an enhanced and/or new wireless handheld computer, namely a PDA, for PDDC of IC bm_comprising a_ntwk, with means comprising a multi-terminal display device which is connected thereto with means of a wireline, wireless, and/or network communication link.

A said display device, comprises for PDDC of simultaneously input multiple “image content” bm_comprising a_ntwk. A said PDDC, comprises with means of a standalone, independent, and/or converged PASPSSC, comprising from multiple devices.

A said display device, comprises a connection from a computer, wireline phone, wireless handheld, and/or mobile phone, for PDDC of IC bm_comprising a_ntwk. A said multi-terminal display device, and/or a variation thereof, comprises being system integrated and/or installed in an automobile, for PDDC comprising simultaneously input multiple “image content”, bm_comprising a_ntwk.

C. Specification—“Prior Application Specification”: End

### A Non-Server or Server Based NIC

A NIC is presented a USER, with means of a non-server-, or server-, based SS. A USER gains access to, and/or using of, a non-server based SS, with means of a standalone or independent software and/or service. Similarly, a USER gains access to, and/or using of, a server based SS that comprises being installed and/or resident in a local and/or remote server, bm_of a_ntwk. The methodologies for access to, and/or using of, (1) a non-server based SS, and (2) a server based SS, are described in paragraphs hereinbelow. The description of (3) a server-based communication, is presented in the paragraph subsequent thereto.

The specification describes the prior-art procedure of setting up of an IUA, for a server based NIC comprising a Converged Platform, in paragraph 4A1. The specification going forward, describes the presenting of an IUA based Converged Platform, namely, a DI Platform and/or CD Platform, in paragraph 4A2; a WP Platform and/or CP Platform, in paragraph 4A3; and a PI Platform, a variation and/or enhancement thereof, in 4A4; for a server based NIIC, NISC, and/or NIPC, by means of a network. The specification describes additionally, a system, process, procedure, product, and/or product-by process, for, and/or of, a user-account holder, comprising an IUA holder, inputting, selecting, and/or modifying of accessing, using, and/or browsing privileges, for a said account holder web presentation, in paragraph 4A5.

C. I. P. Specification—“Prior Application Specification B”: Begin

An enhanced and/or new system, process, procedure, product, and/or product-by-process, of translating for NIIC, NISC, and/or NIPC, is presented in paragraph 5. A said translating, comprises, translating during network communication (“real-time network translating”), with means of a translator in a server, host, user-client, client-user, and/or desktop platform, for PDDC of a real-time network translated IM_COMB bm_of_a_ntwk; and/or translating with means of a translator in a user-client, client-user, and/or desktop platform, for PDDC of translated IM_COMB bm_comprising a_ntwk.

A said translating system, process, procedure, product, and/or product-by-process, comprises being applied to, and/or on, an existing, enhanced, and/or new SS, with means of a translator for real-time network translating and/or PDDC of a real-time network translated IM_COMB, bm_of_a_ntwk.

A said translator, comprises being resident in: a server, host, user-client, client-user, and/or desktop platform, comprising an internet platform, for PDDC of a real-time network translated IM_COMB bm_of_a_ntwk; and/or a user-client, client-user, and/or desktop platform, for translating of a real-time and/or asynchronous IM_COMB bm_comprising a_ntwk. A said translated PDDC enhances a USER's visual and/or audio-visual perception of an asynchronous and/or real-time event, bm_comprising a_ntwk.

=========C.I.P. Specification—“Prior Application Specification B”: End

### 1. A Non-Server Based NIC:

A NIC SS comprising a PASPSSC, without means of a server for data access and/or deposit, for PDDC of IC bm_of_a_ntwk and/or device, is defined herein as a non-server based NIC. A said non-server based NIC, comprises being accessed and/or used, with means of a network and/or device communication channel. A said SS, comprises being installed in a USER device, comprising for external PDDC of IC bm_of_a_ntwk and/or device. A said non-server based NIC, presents for PDDC of “image content” without a server for data access and/or deposit, bm_of_a_ntwk and/or device communication channel.

A heretofore described non-server based NIC, connects to a peer, destination, device, and/or host, with means of an address thereof. A USER, on initiating a communication link to a said peer, destination, device, and/or host, is responded to, by the receiving peer, destination, device, and/or host, which accepts, rejects, and/or presents alternatives, on a said communication link initiating request. A visual and/or audio-visual element, comprises being one-, two-, and/or multi-way communicated with means of a SS installed in said device, between a said communication link initiating device and/or USER, and a said responding peer, destination, device, host, and/or USER, comprising during a communication link initiating request, without a server being present for data access and/or deposit.

A said non-server based NIC, may however, comprise employing a communication server, for PDDC of IC bm_of_a_ntwk and/or device.

### 2. A Server Based NIC:

A NIC SS, comprising a PASPSSC, for data access from, and/or deposit to, a server for PDDC of IC bm_of_a_ntwk, is defined herein as a server based NIC.

A USER connects for access to, and/or using of, a server based NIC, with means comprising an ‘interface’ to a client server. A said ‘interface’ comprises being installed in a USER device, comprising a web browser, for PDDC of IC bm_of_a_ntwk. A said access to, and/or using of, a server based NIC, comprises, a public and/or user-account based website, webpage, and/or host.

A USER, on gaining access to, and/or using of, a said server based NIC, establishes capability for PDDC of “image content” from, and/or to, a public and/or user-account based website, webpage, and/or host bm_of_a_ntwk. A said system, process, procedure, product, and/or product-by-process, is similar to an access, using, and/or browsing, of a public and/or user-account based website, webpage, and/or host, with means comprising a web browser, and/or an e-mail SS account by means of logging thereinto, both of said common prior-art as at the time of invention.

The invention of an enhanced and/or new SS for NIC, comprising a website and/or webpage, presents asynchronous and/or real-time “image content”, comprising bandwidth and bit-rate requirements, for PDDC of IC bm_of_a_ntwk.

### 3. A Server Based Communication:

A system, process, procedure, product, and/or product-by-process, consisting a communication server in the network and/or device communication link, is defined herein as a server based communication. A said server based communication, comprises PDDC of IC bm_of_a_ntwk. The aforesaid contrasts to a non-server based communication, where a communication server is not present in the network and/or device communication link.

### 4. A Converged Platform for NIC

A Converged Platform for NIC comprising NIIC, NISC, and/or NIPC, is presented with means comprising a server based user-account, and/or an internet user-account (“IUA”). The invention herein, describes a Converged Platform with means of an IUA, with similarities for, and/or of, a Converged Platform with means of a server based user-account other than an IUA.

### 4A1. Setting Up of an IUA for a Converged Platform for NIC:

The creation of an internet user-account (“IUA”) for a converged service software and/or software service platform for NIC (“Converged Platform”), is facilitated with means comprising an ‘interface’, to said SS platform, in a local and/or remote server. A USER, on creating an IUA, comprises being presented a Converged Platform for visual and/or audio-visual PDDC comprising IC bm_of_a_ntwk, to and/or from a host, another user-account holder, and/or the public, referred to herein as “another”.

The system, process, and/or procedure, for logging into a said IUA Converged Platform, is similar to logging into an IUA e-mail platform with means comprising a web browser, means with which a said IUA holder gains access to, and/or using of, a CNS, PNS, and/or NS therein, for PDDC comprising IC bm_of_a_ntwk.

Similarly, a USER creates a professional and/or business NIPC IUA Converged Platform, with means comprising an authorization from the entity providing a said. A USER, on creating a said NIPC IUA, logs thereinto similar to a non-NIPC IUA, comprising additional authorization from the said entity, for PDDC comprising IC bm_of_a_ntwk.

A Converged Platform with means of an IUA, presents a SS comprising a PASPSSC, for convergence in (1) communication, (2) communication and web presenting, (3) web presenting, and/or (4) web presenting and communication (“C_CWP_WP_and/or_WPC”), with means comprising respectively of: (1) more than one communication PASPSSC, for a one-, two-, and/or multi-way communication, with means of a user-account login; (2) a minimum one of a said communication PASPSSC, and a web presenting PASPSSC, comprising a web template, of “image content” and/or IM_COMB comprising a self-profile and/or information; (3) a web presenting PASPSSC, comprising a web template, of “image content” and/or IM_COMB; and/or (4) a web presenting PASPSSC, comprising a web template, of “image content” and/or IM_COMB, and a communication PASPSSC comprising “image content” and/or IM_COMB and/or for a real-time comprising asynchronous communication (“communication PASPSSC”); all of said for PDDC comprising IC bm_of_a_ntwk.

A Converged Platform with means of an IUA, comprises, a ‘Desktop Interface Platform’ (“DI Platform”), ‘Client Desktop Platform’ (“CD Platform”), ‘Web Presentation Platform’ (“WP Platform”), and/or ‘Client Presentation Platform’ (“CP Platform”), for PDDC comprising IC bm_of_a_ntwk. A Converged Platform with means of an IUA, comprises any combination of the named Converged Platforms, for PDDC comprising IC bm_of_a_ntwk.

A Converged Platform comprises presenting to the IUA holder, for inputting, selecting, and/or modifying, of accessing, using, and/or browsing privileges, for an enhanced web presenting to, and/or communication from, another, for PDDC comprising IC bm_of_a_ntwk. A communication and/or web presenting, with means comprising a Converged Platform, comprises a ‘Presentation Interface Platform’ (“PI Platform”) for interactive web presenting, for PDDC comprising IC bm_of_a_ntwk.

4A2. A Desktop Interface Platform and/or Client Desktop Platform:

A NIIC, NISC, and/or NIPC USER, on creating of an IUA for a Converged Platform for NIC, is presented comprising, a ‘Desktop Interface Platform’ (“DI Platform”) for communication, and/or a ‘Client Desktop Platform’ (“CD Platform”) for communication and web presenting, for PDDC comprising IC bm_of_a_ntwk.

A DI Platform, comprises a ‘Desktop Interface page Platform’ (“DI page Platform”) and/or ‘Desktop Interface page’ (“DI Page”), collectively referred to herein as a “DI Platform and/or a variation thereof”, or simply a DI Platform, for converged communication for PDDC comprising IC bm_of_a_ntwk.

Similarly, a CD Platform, comprises a ‘Client Desktop page Platform’ (“CD page Platform”), ‘Client Desktop Page’ (“CD page”), and/or ‘DI sub-platform’, collectively referred to herein as a “CD Platform and/or a variation thereof”, or simply a CD Platform, for converged communication and web presenting for PDDC comprising IC bm_of_a_ntwk.

A DI Platform, comprises more than one communication PASPSSC, with means of a user-account login, for PDDC comprising IC bm_of_a_ntwk. Similarly, a CD Platform, comprises a communication PASPSSC, and a web presenting PASPSSC, comprising a web template, of “image content” and/or IM_COMB, with means of a user-account, for PDDC comprising IC bm_of_a_ntwk. A said DI Platform and/or CD Platform, comprises conventional static and/or dynamic properties for access, using, and/or creating thereof. A DI Platform comprises being present in a CD Platform, and is therein referred to as a “DI sub-platform”.

An enhanced Converged Platform, comprising an enhanced DI Platform and/or CD Platform, comprises additional features of scalability, inter- and/or intra-platform movability, and/or dynamic properties, for a program, application, service, platform, service software, software service, an element, content, and/or a combination thereof (“PASPSSECC”). A said enhanced Converged Platform, facilitates porting comprising moving, dragging-n-dropping, downloading, and/or uploading, of an external PASPSSECC thereinto and/or off-therefrom, for PDDC comprising IC bm_of_a_ntwk.

### A Desktop Interface Platform (“DI Platform”):

An IUA holder comprises being presented a DI Platform and/or a variation thereof, with means of a user-account login, for converged communication, consisting more than one communication PASPSSC, for PDDC comprising IC bm_of_a_ntwk. A said DI Platform, comprises being accessed, used, and/or browsed, with means of an interface comprising a web browser, for PDDC comprising IC bm_of_a_ntwk. A PASPSSC of, and/or for, a DI Platform, comprises an internet chat, pager, e-mail, ‘internet-phone’, and/or the like.

A DI Platform consists limited dynamic properties, in that it does not comprise capabilities for moving, and/or dragging-n-dropping, of an external communication PASPSSECC thereinto and/or off-therefrom. An enhancement of the said comprises an enhanced DI Platform, comprising dynamic properties for moving, dragging-n-dropping, downloading, and/or uploading, of an external communication PASPSSECC thereinto and/or off-therefrom, for PDDC comprising IC bm_of_a_ntwk.

### A Client Desktop Platform (“CD Platform”):

An IUA holder comprises being presented a CD Platform and/or a variation thereof, with means of a user-account, for converged communication and web presenting, with means of a communication PASPSSC, and a web presenting PASPSSC, for PDDC comprising IC bm_of_a_ntwk. A said CD Platform, comprises being accessed, used, browsed, and/or web presented, with means of an interface comprising a web browser, for PDDC comprising IC bm_of_a_ntwk. A said CD Platform PASPSSC, comprises a pager, internet chat, e-mail, ‘internet-phone’, web viewer, web browser, and/or a like; and a web presenting PASPSSC, comprising a web template, of “image content” and/or IM_COMB comprising a self-profile and/or information; for PDDC comprising IC bm_of_a_ntwk.

A said CD Platform consists limited dynamic properties, in that it does not comprise capabilities for moving, and/or dragging-n-dropping, of an external communication nor web presenting PASPSSECC thereinto and/or off-therefrom. An enhancement of the said, comprises an enhanced CD Platform, comprising dynamic properties for moving, dragging-n-dropping, downloading, and/or uploading, of an external communication and/or web presenting PASPSSECC, thereinto and/or off-therefrom, for PDDC comprising IC bm_of_a_ntwk.

An Enhanced DI Platform and/or CD Platform:

An enhanced DI Platform and/or CD Platform, with means comprising an IUA, is similar to a Unix and/or Windows OS folder-file system, comprising for selecting, inputting, fusing, integrating, and/or porting, of a communication and/or web presenting PASPSSECC, comprising a web template, thereinto and/or off-therefrom. A said enhanced DI Platform and/or CD Platform, is otherwise similar respectively to a DI Platform and/or CD Platform.

A CD Platform of a user-account holder, comprises the likes of: CD Page1, an internet-phone; CD Page2, an e-mail, page, and/or text chat; DI sub-platform3, an ‘internet-phone’ and/or group posting, comprising for group calling and/or posting; CD Page4, the IUA holder directory of contacts; DI Page5, a web viewer and/or browser for the IUA holder access, using, and/or browsing of a website, webpage, and/or PI Platform, of another; and/or CD page Platform6, a Client Presentation Platform; where a said CD Platform comprises a PASPSSC for PDDC comprising IC bm_of_a_ntwk.

A Converged Platform, namely a CD Platform of an IUA holder, comprising a CNS, PNS, and/or NS, is illustrated in FIG. 24. A said CD Platform, comprises a CD page Platform, CD page, DI sub-platform, a series and/or multiples thereof, for PDDC comprising IC bm_of_a_ntwk. The said figure shows a CD page and/or DI sub-platform, named “Moving Picture Communication” consisting an ‘internet-phone’ for PDDC comprising “image content”, to and/or from another, bm_of_a_ntwk. The said figure also shows a CD page Platform and/or DI sub-platform, named “E-mail, Page, Text Chat” comprising an e-mail, page, and/or text chat PASPSSC, for PDDC comprising “image content”, to and/or from another, bm_of_a_ntwk. A said PASPSSC of, and/or for, a CD Platform, comprises being accessed and/or used from therewithin, an enlargement and/or minimization thereof.

A CD page Platform, CD page, and/or DI sub-platform, comprises displaying a header, for the said user-account holder selecting for access and/or usage thereof. A said header, comprises the name and/or description of the PASPSSC thereon. The said figure shows said headers, on the upper portion of the illustrated CD Platform, named, ‘Self-Profile Information’, ‘Client Presentation Platform’, ‘Moving Picture Communication’, ‘E-mail, Page, Text Chat’, ‘Group Call/Posting’, ‘Contacts’, ‘Presentation Interface I’, and ‘Presentation Interface II’.

A PASPSSC of, and/or for, a CD Platform, comprises being scalable, enlargeable, and/or minimizable. A CD Platform, CD page Platform, and/or CD page, comprises sub-interfaces therewithin, for the said user-account holder access, using, and/or browsing, for PDDC comprising IC bm_of_a_ntwk.

An illustration of said user-account holder access, using, and/or browsing of a web presentation of another, with means of sub-interface headers named “Presentation Interface I”, and “Presentation Interface II”, is shown in FIG. 24. A said web presentation of another, comprises being accessed, used, and/or browsed, with means of a CD Platform and/or DI sub-platform web viewer and/or browser, for PDDC comprising IC bm_of_a_ntwk. A said user-account holder, may in the alternative gain access, using, and/or browsing, of a public and/or private website, webpage, and/or a like, with means of a said web viewer and/or browser, for PDDC comprising IC bm_of_a_ntwk.

A NIIC, NISC, and/or NIPC USER, on setting up of an IUA for a Converged Platform, comprises being presented, a DI Platform for converged communication, and/or a CD Platform for converged communication and web presenting, for PDDC comprising IC bm_of_a_ntwk. An enhancement of the said comprises presenting an IUA holder an enhanced Converged Platform, comprising, an enhanced DI Platform for converged communication with dynamic features for porting an external communication PASPSSECC, and/or an enhanced CD Platform for converged communication and web presenting with dynamic features for porting an external communication and/or web presenting PASPSSECC, for PDDC comprising IC bm_of_a_ntwk.

A said user-account holder, on being presented an enhanced DI Platform and/or CD Platform, is enabled porting a PASPSSECC and/or “image content”, into and/or off-from, a said enhanced Converged Platform, for PDDC comprising IC bm_of_a_ntwk.

4A3. A Web Presentation Platform and/or Client Presentation Platform:

A NIIC, NISC, and/or NIPC USER, on creating of an IUA for a Converged Platform for NIC, is presented comprising, a ‘Web Presentation Platform’ (“WP Platform”) for web presenting, and/or a ‘Client Presentation Platform’ (“CP Platform”) for web presenting and communication, for PDDC comprising IC bm_of_a_ntwk.

A WP Platform, comprises a ‘Web Presentation page Platform’ (“WP page Platform”) and/or ‘Web Presentation page’ (“WP page”), collectively referred to herein as a “WP Platform and/or a variation thereof”, or simply a WP Platform, for converged web presenting of “image content” and/or IM_COMB, for PDDC comprising IC bm_of_a_ntwk.

Similarly, a CP Platform, comprises a ‘Client Presentation page Platform’ (“CP page Platform”), ‘Client Presentation Page’ (“CP page”), and/or ‘WP sub-platform’, collectively referred to herein as a “CP Platform and/or a variation thereof”, or simply a CP Platform, for converged web presenting and communication, for PDDC comprising IC bm_of_a_ntwk.

A WP Platform, comprises a Converged Platform, with means of a user-account, for web presenting to another, with means of a web presenting PASPSSC, comprising a web template, of “image content” and/or IM_COMB, for PDDC comprising IC bm_of_a_ntwk. Similarly, a CP Platform, comprises a Converged Platform, with means of a user-account, for web presenting to another, with means of a web presenting PASPSSC, comprising a web template, of “image content” and/or IM_COMB, and a communication PASPSSC with “image content”, IM_COMB, and/or for real-time comprising asynchronous communication (“communication PASPSSC”), for PDDC comprising IC bm_of_a_ntwk. A said WP Platform and/or CP Platform, comprises conventional static and/or dynamic properties for creating, modifying, and/or web presenting to another, with means of a SS comprising a website, webpage, and/or PI Platform. A WP Platform, comprises being present in a CP Platform, and is therein referred to as a “WP sub-platform”.

An enhanced Converged Platform, comprising an enhanced WP Platform and/or CP Platform, comprises additional features of scalability, inter- and/or intra-platform movability, and/or dynamic properties, for a PASPSSECC. A said enhanced Converged Platform, facilitates porting comprising moving, dragging-n-dropping, downloading, and/or uploading, of an external PASPSSECC thereinto and/or off-therefrom, for PDDC comprising IC bm_of_a_ntwk.

### A Web Presentation Platform (“WP Platform”):

An IUA holder comprises being presented a WP Platform and/or a variation thereof, with means of a user-account, for converged web presenting, with means of a web presenting PASPSSC, for PDDC comprising IC bm_of_a_ntwk. A said WP Platform comprises a website template, webpage template, a series and/or multiples thereof, referred to herein as a “web template”, for creating, modifying, and/or presenting to another, of a web presenting with means of an interface comprising a web browser, for PDDC comprising IC bm_of_a_ntwk. A said user-account holder, comprises utilizing a said web template for inputting, fusing, and/or integrating, of “image content” and/or IM_COMB, for a said web presenting for PDDC comprising IC bm_of_a_ntwk.

A said WP Platform consists limited dynamic properties, in that it does not comprise capabilities for moving, and/or dragging-n-dropping, of an external web presenting PASPSSECC thereinto and/or off-therefrom. An enhancement of the said, comprises an enhanced WP Platform, comprising dynamic properties for moving, dragging-n-dropping, downloading, and/or uploading, of an external web presenting PASPSSECC thereinto and/or off-therefrom, for PDDC comprising IC bm_of_a_ntwk.

### A Client Presentation Platform (“CP Platform”):

An IUA holder comprises being presented a CP Platform and/or a variation thereof, with means of a user-account, for converged web presenting and communication, with means of a web presenting PASPSSC, and a communication PASPSSC, for PDDC comprising IC bm_of_a_ntwk. A said CP Platform, comprises, a web presenting PASPSSC for, and/or of, the said user-account holder “image content” and/or IM_COMB, and a communication PASPSSC, for PDDC comprising IC bm_of_a_ntwk. A said CP Platform, comprises being accessed, used, browsed, and/or utilized, with means comprising a web browser, and additionally, for “image content”, IM_COMB, and/or real-time comprising asynchronous communication with the web presenter, for PDDC comprising IC bm_of_a_ntwk.

A said CP Platform consists limited dynamic properties, in that it does not comprise capabilities for moving, and/or dragging-n-dropping, of an external web presenting nor communication PASPSSECC thereinto and/or off-therefrom. An enhancement of the said, comprises an enhanced CP Platform, comprising dynamic properties for moving, dragging-n-dropping, downloading, and/or uploading, of an external web presenting and/or communication PASPSSECC, thereinto and/or off-therefrom, for PDDC comprising IC bm_of_a_ntwk.

An Enhanced WP Platform and/or CP Platform:

An enhanced WP Platform and/or CP Platform, with means comprising an IUA, is similar to a Unix and/or Windows OS folder-file system, comprising for selecting, inputting, fusing, integrating, and/or porting, of a web presenting and/or communication PASPSSECC, comprising a web template and/or a communication PASPSSC, thereinto and/or off-therefrom. A said enhanced WP Platform and/or CP Platform, is otherwise similar respectively to a WP Platform and/or CP Platform.

A said user-account holder, on being presented a Converged Platform comprising a WP Platform, and/or CP Platform, comprises inputting, fusing, and/or integrating of “image content”, IM_COMB, and/or a communication PASPSSC, for facilitating a converged web presenting, and/or web presenting and communication, for PDDC comprising IC bm_of_a_ntwk. A said “communication PASPSSC”, comprises, a communication PASPSSC comprising “image content” and/or IM_COMB, and/or a real-time comprising asynchronous communication PASPSSC, for PDDC comprising IC bm_of_a_ntwk.

A CP Platform of a user-account holder, comprises the likes of: CP page 1, a self-profile and/or information comprising “image content”; CP page2, a list of favorite hyperlinks; CP page3, a ‘moving picture’ of a graduation; CP page Platform4, personal album of images; CP page5, an ‘internet-phone’ and/or a link thereto; and/or WP sub_platform6, a link to an internet chat and/or messager PASPSSC; where a said CP Platform comprises a PASPSSC for PDDC comprising IC bm_of_a_ntwk.

A Converged Platform, namely a CP Platform of an IUA holder, comprising a CNS, PNS, and/or NS, is illustrated in FIG. 25. A said CP Platform, comprises a CP page Platform, CP page, WP sub-platform, a series and/or multiples thereof, for PDDC comprising IC bm_of_a_ntwk. The aforesaid is shown on said figure, comprising said user-account holder creation with headers named, ‘Self-Profile Information’, ‘PI Access Privileges’, ‘Image I, II’, ‘Private Album I, II, III’, ‘Moving Picture I, II, III, IV’, ‘Favorite Hyperlinks’, ‘Communication: Internet Chat’, and ‘Communication: Internet-Phone’, of, and/or for, the said user-account holder creating, modifying, and/or presenting to another, of a converged web presenting and communication, for PDDC comprising IC bm_of_a_ntwk.

A said user-account holder, when creating, modifying, and/or presenting to another, of a web presentation with means of a CP Platform, comprises utilizing the header buttons shown on the top quartile of the illustration, for access, using, and/or browsing of a said. A CP Platform, on being accessed by the said user-account holder, comprises presenting a web template for inputting, fusing, and/or integrating of “image content”, IM_COMB, and/or a communication PASPSSC, thereinto. A said user-account holder creation, usage, and/or browsing of a CP Platform, comprising CP page Platforms named ‘Image’, ‘Private Album’, and ‘Moving Picture’, is illustrated in FIG. 25.

A NIIC, NISC, and/or NIPC USER, on setting up of an IUA for a Converged Platform, comprises being presented, a WP Platform for converged web presenting, and/or a CP Platform for converged web presenting and communication, for PDDC comprising IC bm_of_a_ntwk. An enhancement of the said, comprises presenting a said user-account holder, an enhanced Converged Platform, comprising, an enhanced WP Platform for converged web presenting with dynamic features for porting an external web presenting PASPSSECC, and/or an enhanced CP Platform for converged web presenting and communication with dynamic features for porting an external web presenting and/or communication PASPSSECC, for PDDC comprising IC bm_of_a_ntwk.

A said user-account holder, on being presented an enhanced WP Platform and/or CP Platform, is enabled porting a PASPSSECC, “image content”, and/or IM_COMB, thereinto and/or off-therefrom, for PDDC comprising IC bm_of_a_ntwk.

An IUA web presentation with privileges for access, usage, and/or browsing: An IUA web presentation, with means comprising a website and/or webpage, comprises access, usage, and/or browsing privileges therefor. A said user-account holder, comprises inputting and/or selecting of a said privilege, comprising with means of a WP Platform, CP Platform, and/or an enhancement thereof, for a said web presentation. The objective of a said privilege for a web presentation, comprises for, selective-permitting and/or restricting of a said web presenting to another, for PDDC comprising IC bm_of_a_ntwk.

A said privilege, in addition to a default public privilege, comprises a secret, confidential, private, semi-private, group, semi-public, on-demand, and/or a like privilege, for a WP Platform, CP Platform, an enhancement, element, content, and/or a combination thereof, comprising with means of a drop-down menu.

A CP Platform, with a said privilege for access, usage, and/or browsing, comprise the likes of: CP page1, a public self-profile and/or information comprising “image content”; CP page2, a semi-public list of favorite hyperlinks; CP page3, a semi-private ‘moving picture’ of a graduation; CP page Platform4, a private personal album of images; CP page5, a semi-public ‘internet-phone’ and/or a link thereto; and/or WP sub-platform6, a semi-public internet chat and/or messager PASPSSC; where a said CP Platform facilitates said user-account holder, for creating, modifying, and/or presenting to another, of a web presentation comprising privileges for access, usage, and/or browsing, for PDDC comprising IC bm_of_a_ntwk.

### 4A4. A Presentation Interface Platform (“PI Platform”) for NIC:

A NIIC, NISC, and/or NIPC user-account holder, comprising an IUA holder, facilitates a web presenting and/or custom web presenting to another, with means comprising of a ‘Presentation Interface Platform’ (“PI Platform”), for PDDC comprising IC bm_of_a_ntwk.

A PI Platform, comprises a ‘Presentation Interface page Platform’ (“PI page Platform”) and/or ‘Presentation Interface Page’ (“PI page”), collectively referred to herein as a “PI Platform and/or a variation thereof”, or simply a PI Platform, for converged web presenting and/or communication, for PDDC comprising IC bm_of_a_ntwk.

A said PI Platform, may comprise a PI macro- and/or sub-platform, comprising said user-account provider static and/or dynamic privileges, for accessing, using, and/or browsing, a said web presenting and/or communication by another, for PDDC comprising IC bm_of_a_ntwk.

A user-account holder web presenting, with means comprising a website, webpage, a series and/or multiples thereof, comprises a said PI Platform and/or a variation thereof, for a said web presenting and/or custom web presenting, for PDDC comprising IC bm_of_a_ntwk. A said user-account holder web presentation, comprises being transformed with means of, and/or into, a PI Platform consisting said privileges for, and/or during, a said web presenting to another, with means of automation and/or automated customization. A web presenting with means of a PI Platform, may comprise a custom privilege comprising on the profile and/or information of the another seeking accessing, using, and/or browsing thereof.

A said web presenting and/or custom web presenting, comprises requests for granting a privilege for accessing, using, and/or browsing, from a web presented, to the web presenting user-account holder and/or administrator. The assignability of a privilege during a web presenting, characterizes a said PI Platform adaptive; whereas grantability by the said user-account holder and/or administrator of a said request for privilege, characterizes a said PI Platform adaptable.

A said another, accessing, using, and/or browsing of a said web presenting or a customized web presenting, may employ a SS thereof, for: an accessing, using, and/or browsing a web presenting of “image content”; a one-, two-, and/or multi-way communication with a said presenting user-account holder; and/or requesting for granting of a privilege on a restricted web presenting from the web presenter and/or administrator; for PDDC comprising IC bm_of_a_ntwk.

FIG. 26 illustrates a web presenting, with means comprising a CP Platform shown in FIG. 25, with a static, dynamic, and/or customized privilege, for accessing, using, and/or browsing of a said web presenting by another, with means comprising a website, webpage, and/or PI Platform. A said CP Platform, consisting a said privilege for accessing, using, and/or browsing by another, is transformed into a PI Platform, for, and/or during, presenting to another, for PDDC comprising IC bm_of_a_ntwk.

A custom privilege, comprising a static and/or dynamic privilege, on the profile and/or information of the web presentation accessing, using, and/or browsing another, and comprises being originally input and/or selected by the said web presenter and/or administrator, with means comprising a Converged Platform. A said custom privilege, additionally comprises, said user-account provider privileges comprising a PI macro- and/or sub-platform.

A web presenting to another, comprising said custom privileges, is presented with means comprising a PI Platform, for PDDC comprising IC bm_of_a_ntwk. As shown in FIG. 26, an “access restricted” message on a web presenting; or an “access restricted” message on a customized web presenting; comprising with means of a PI Platform, is shown on the web presenting with a header named “Image II”, for accessing, using, and/or browsing thereof by the said another.

A said another, seeking accessing, using, and/or browsing, of a said restricted web presenting and/or customized web presenting, with means comprising a PI Platform, may request granting of a privilege, for a said restricted, from the web presenter and/or administrator, for PDDC comprising IC bm_of_a_ntwk.

A said requesting of privilege for accessing, using, and/or browsing by a said another, comprises being facilitated with means from said web presenting, comprising said website, webpage, PI Platform, an element and/or content thereof, comprising with means of the header named ‘PI Access Request’ as illustrated in FIG. 26. A requesting of a said privilege, if and when granted by the web presenter and/or administrator, enables a said requesting restricted another, for accessing, using, and/or browsing of an originally restricted web presenting, for PDDC comprising IC bm_of_a_ntwk.

A user-account holder's web presenting, and/or custom web presenting, with means of a website, webpage, and/or PI Platform, comprises the likes of: PI page1: a public self-profile and/or information comprising image; PI page Platform2: a private personal album of images; PI page3: an on-demand ‘moving picture’ of a wedding; PI page4: a semi-private ‘moving picture’ of a ski-trip; PI page Platform5: a semi-public album of a graduation; and/or PI page Platform6: an on-demand ‘moving picture’ of a party; where a said for PDDC comprising IC bm_of_a_ntwk.

4A5. An IUA Holder Web Presenting PI Platform with Adaptive Modification:

An IUA holder, creates, modifies, and/or presents to another, of a self-profile and/or information, for PDDC comprising IC bm_of_a_ntwk. A said web presenting comprises being adaptive, dependent comprising on the profile and/or other information of a said another, seeking access, usage, and/or browsing thereof. A said IUA holder modifiable web presenting, and a said another's access, usage, and/or browsing, adaptive DI Platform, CD Platform, WP Platform and/or CP Platform, presents an adaptive system, process, procedure, product, and/or product-by-process, for visual and/or audio-visual PDDC comprising IC bm_of_a_ntwk.

An another seeking access, usage, and/or browsing, of an IUA holder's web presenting, consisting a static and/or dynamic custom restriction, may request the web presenter for granting a privilege on a said restricted web presenting, with means comprising said web presenting website, webpage, and/or PI Platform. A said request for granting a privilege on a restriction, comprises being facilitated with means of a website, web page, and/or PI Platform, with the header named ‘PI Access Request’ as shown in FIG. 26, and/or with means of a request from the said restricted element and/or content of said web presenting. The said web presenter and/or administrator, on a request for privilege from a said another, comprises granting and/or denying a said request for access, usage, and/or browsing, comprising manually and/or with automation, with means from said user-account holder platform, comprising a Converged Platform, for PDDC comprising IC bm_of_a_ntwk.

C.I.P. Specification—“Prior Application Specification B”: Begin

### 5. A Translating Methodology for NIC:

Since the introduction of the internet, a multitude of SS, comprising a PASPC, is employed around the networked globe. The invention herein, presents an enhanced and/or new system, process, procedure, product, and/or product-by-process, of, and/or for, a SS for PDDC of a real-time network translated IM_COMB bm_of_a_ntwk. For purposes of this specification, PDDC of a real-time network translated IM_COMB bm_of_a_ntwk, includes, PDDC of an asynchronous, real-time network translated IM_COMB bm_of_a_ntwk.

The enhanced and/or new translating system, process, procedure, product, and/or product-by-process, presents a SS comprising, for, a real-time network translating during a one-, two-, and/or multi-way PDDC of IM_COMB bm_of_a_ntwk, PDDC of a real-time network translated IM_COMB bm_of_a_ntwk, and/or translating of real-time and/or asynchronous IM_COMB on a user-client, client-user, and/or desktop platform, with a resultant performance in a USER language of choice. The objective of a said enhanced and/or new translating, comprises, presenting a real-time network translated ‘moving picture’ comprising associated audio if any, and/or translating with means of a translator in a user-client, client-user, and/or desktop platform, for PDDC of translated IM_COMB.

To clarify, a said translating is facilitated with means of a real-time network translator in a server, host, user-client, client-user, and/or desktop platform; and/or a translator for IM_COMB in a user-client, client-user, and/or desktop platform. An aforesaid, comprises being employed, for real-time network translating of a SS, comprising a website, webpage, and/or PI Platform; and/or for translating IM_COMB on a user-client, client-user, and/or desktop platform, comprising a Converged Platform, bm_comprising a_ntwk.

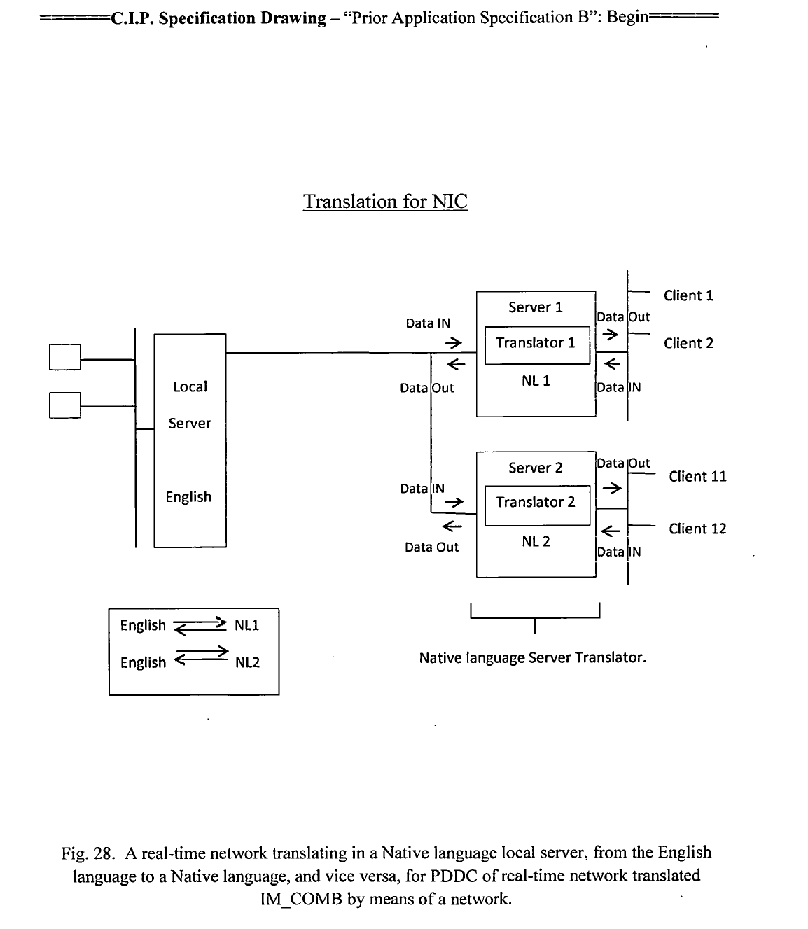

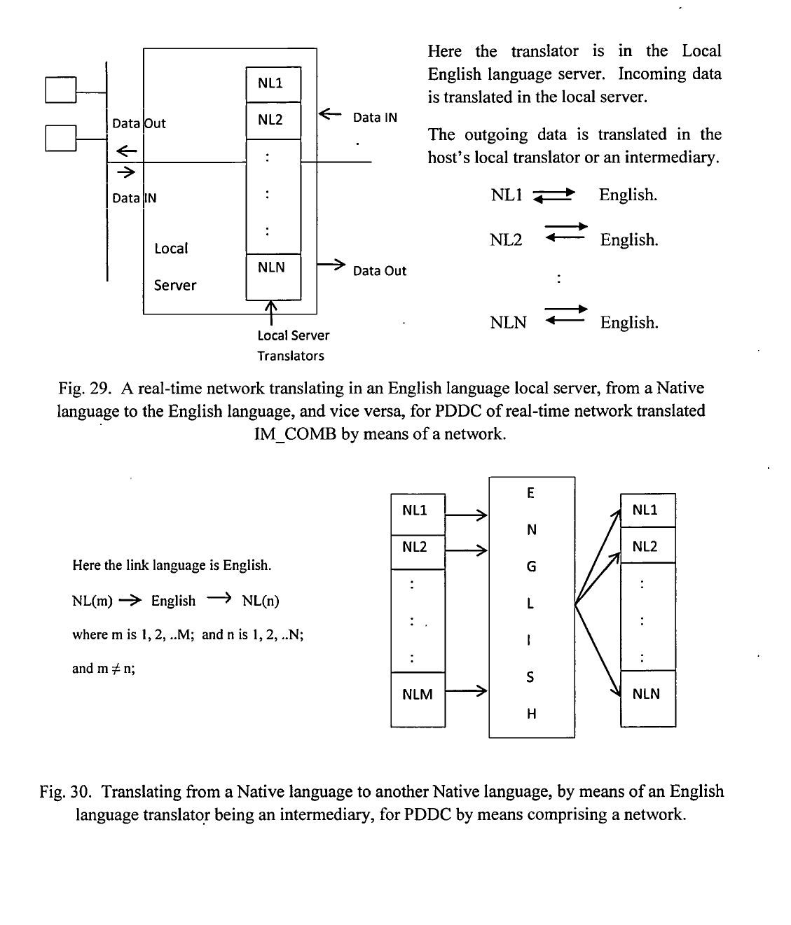

FIGS. 28, and 29, illustrate an enhanced and/or new real-time network translating of IM_COMB bm_of_a_ntwk. A said real-time network translating of IM_COMB, and/or translating with means of a translator in a user-client, client-user, and/or desktop platform, is an enhancement over prior-art, and comprises being employed during usage, comprising creating, storing, browsing, and/or PDDC of IM_COMB bm_of_a_ntwk, in (1) the English language, and/or (2) another language of choice (“Native language”).

FIG. 28 illustrates a real-time network translating in a Native language local server and/or host, from a Native language to the English language, and vice versa, for PDDC of real-time network translated IM_COMB bm_of_a_ntwk. The said figure shows outgoing data in a Native language NL1, and/or NL2, being translated, to the English language and/or another Native language, whereupon, the said translated data is communicated for PDDC bm_of_a_ntwk. The reverse process is achieved in a similar manner, where a reverse translator at the Native language's local server and/or host, translates network communicated incoming data in the English language and/or another Native language to a corresponding Native language NL1, and/or NL2, for PDDC bm_of_a_ntwk. A said translating comprises being employed for PDDC of a real-time network translated IM_COMB bm_of_a_ntwk. A said translating, comprises a forward and/or reverse translator, for translating text, voice, and/or “image content”.

A real-time comprising asynchronous translation may alternatively be facilitated in a Native language USER platform, comprising a user-client, client-user, and/or desktop platform, for a real-time and/or asynchronous IM_COMB translating, for PDDC of translated IM_COMB bm_comprising a_ntwk.

FIG. 29 illustrates real-time network translating in an English language local server and/or host, from the English language to a Native language, and vice versa, for PDDC of real-time network translated IM_COMB bm_of_a_ntwk. The said figure shows data in a Native language NL1, or NL2, being network communicated, and thereupon translated to the English language and/or another Native language, for PDDC bm_of_a_ntwk. The reverse process is achieved in a similar manner, with a reverse translator at the English language's local server, and/or host, real-time network translating outgoing data in the English language and/or a Native language, to a corresponding Native language NL1, and/or NL2, and thereupon communicating for PDDC of real-time network translated IM_COMB bm_of_a_ntwk. A said translating comprises being employed for PDDC of a real-time network translated IM_COMB bm_of_a_ntwk. A said translating, comprises a forward and/or reverse translator, for translating text, voice, and/or “image content”.

A real-time comprising asynchronous translation may alternatively be facilitated in an English language USER platform, comprising a user-client, client-user, and/or desktop platform, for a real-time and/or asynchronous IM_COMB translating, for PDDC of translated IM_COMB bm_comprising a_ntwk.

A said translating system, process, procedure, product, and/or product-by-process, may comprise, only a forward translator, only a reverse translator, a forward translator locally and a reverse translator remotely, or a forward translator remotely and a reverse translator locally, for PDDC of translated IM_COMB bm_comprising a_ntwk.

FIG. 30 illustrates a system, process, procedure, product, and/or product-by-process, for translating data from a Native language to another Native language, such as NL1 to NL2, and/or NL2 to NL1, with means of an English language translator being an intermediary or link. A said translating comprises, by means of translating a Native language to the English language, and thereupon translating, the said translated English language to another Native language. The said translators, from a Native language to the English language, and from the English Language to another Native language, are independent of translator location, where the said coexist in a local and/or remote server, host, and/or platform; or in the alternative, canonically separated with the translator to the English language in the local server, platform, and/or host, and the translator to the other Native language in a remote server and/or platform, or vice versa.

A generalization of a said translating, comprises translating from any of one language to another language, with a chosen language as an intermediary. The translating system, process, procedure, product, and/or product-by-process, of this invention, comprises for text, voice, and/or “image content”.

An enhanced and/or new translating system, process, procedure, product, and/or product-by-process of this invention, presents to a USER, real-time network translating and/or PDDC of a real-time network translated IM_COMB, bm_of_a_ntwk; and/or translating on a user-client, client-user, and/or desktop platform, for PDDC of translated IM_COMB bm_comprising a_ntwk, whereupon presenting enhancements in audio, visual, and/or audio-visual PDDC of IM_COMB bm_comprising a_ntwk.

===C.I.P. Specification—“Prior Application Specification B”: End

### A BRIEF SUMMARY OF SPECIFICATION

The specification of this invention, described visual and/or audio-visual PDDC of “image content”, with means comprising a SS, bm_comprising a_ntwk. The said description of a system, process, procedure, product, product-by-process, and/or service, for PDDC of “image content”, wherein enhances network integrated information, social, and/or professional communication, referred to respectively, as NIIC, NISC, and/or NIPC.

In having described the scope of NIC, the specification described enhancements for NIIC, NISC, and/or NIPC, comprising a system, process, procedure, product, product-by-process, and/or service, for PDDC of IC bm_comprising a_ntwk and/or PDDC comprising IC bm_of_a_ntwk.

In summarizing, the specification described, an enhanced and/or new system, process, procedure, product, product-by-process, and/or service, of, and/or for:
a hardware, SS, comprising a website and/or webpage, for a one-, two-, and/or multi-way PDDC of asynchronous and/or real-time ‘moving picture’, with means comprising data packets, by means of an online, computer, phone, and/or hybrid network;
a hardware, SS, comprising a website and/or webpage, for a one-, two-, and/or multi-way PDDC of asynchronous and/or real-time “image content”, comprising image, ‘moving picture’, and/or associated audio if any, with means comprising data packets, by means of a phone and/or hybrid network;
an ‘internet-phone’, for a one-, two-, and/or multi-way PDDC of real-time and/or asynchronous “image content”, comprising image, ‘moving picture, and/or associated audio if any, transmitted with means comprising data packets, bm_of_a_ntwk;
a wireless handheld computer, or a wireline phone, wireless handheld, and/or mobile phone, for PDDC of IC bm_comprising a_ntwk;
a converged SS, comprising a Converged Platform, with means comprising a user-account and/or an IUA, for converged communication, communication and web presenting, web presenting, and/or web presenting and communication, for PDDC comprising IC bm_of_a_ntwk. A said Converged Platform for NIIC, NISC, and/or NIPC, comprises namely, a DI Platform, CD Platform, WP Platform, CP Platform, and/or PI Platform, for PDDC comprising IC bm_of_a_ntwk;
real-time network translating and/or PDDC of a real-time network translated IM_COMB bm_of_a_ntwk; and/or translating of real-time and/or asynchronous IM_COMB, with means of a translator in a user-client, client-user, and/or desktop platform;
a PDDC of “image content” and associated audio if any, transmitted with means of a combined “image content” data packet, consisting said “image content” image and audio data, bm_of_a_ntwk;
a PDDC of “image content” and associated audio if any, and/or IM_COMB, transmitted with means comprising data packets, consisting with means of a UIDCL bm_of_a_ntwk;

In concluding, the specification described PDDC of “image content”, comprising ‘moving picture’, image, and/or associated audio if any, with means of a hardware, service software, and/or software service; comprising network, device, and/or product specific exclusions; by means comprising a network.

I claim: C: Specification claim—“Prior Application Specification A”: Begin

1. An enhanced and/or new system, process, procedure, product, and/or product-by-process: a hardware, service software, software service, and/or a combination thereof, for, and/or of, a Network Integrated Communication (“NIC”), namely an enhanced and/or new Network Integrated Information Communication (“NIIC”), Network Integrated Social Communication (“NISC”), and/or Network Integrated Professional communication (“NIPC), for a one-, two-, and/or multi-way, performance displaying during communication (“PDDC”) of asynchronous and/or real-time “image content” comprising associated audio if any, excluding as specified only of prior-art one-way static image by means of a computer network, transmitted with means comprising data packets, by means of a network.

2. An enhanced and/or new system, process, procedure, product, and/or product-by-process: a hardware, service software, software service, and/or a combination thereof, for, and/or of, comprising a NIC of claim 1, a website, and/or webpage, for a one-, two-, and/or multi-way, performance displaying during communication (“PDDC”) of asynchronous and/or real-time “image content”, comprising of ‘moving picture’ and/or associated audio if any, transmitted with means comprising data packets, by means of an online, computer, and/or hybrid network, with elements comprising,
text, hyperlink, graphics, other audio, image, and/or other performing element comprising a program, application, service, platform, and/or a combination thereof. C. Specification claim “Prior Application Specification A”: End C. Specification claim “Prior Application Specification”: Begin

3. An enhanced and/or new system, process, procedure, product, and/or product-by-process: a hardware, service software, software service, and/or a combination thereof, for, and/or of, comprising a NIC of claim 1, a website, and/or webpage, for a one-, two-, and/or multi-way, performance displaying during communication of asynchronous and/or real-time “image content”, comprising of image, moving picture, and/or associated audio if any, transmitted with means comprising data packets, by means of a phone and/or hybrid network, with elements comprising,
text, hyperlink, graphics, other audio, and/or other performing element comprising a program, application, service, platform, and/or a combination thereof. C. Specification claim—“Prior Application Specification”: End C. Specification claim—“Prior Application Specification A”: Begin

4. An enhanced and/or new system, process, procedure, product, and/or product-by-process, comprising a NIC of claim 1: an internet-phone′, a hardware, service software, software service, and/or a combination thereof, for, and/or of, a user-initiated call request-acceptance interactive (“UICRA”), one-, two-, and/or multi-way, performance displaying during communication of real-time and/or asynchronous “image content” comprising of ‘moving picture’, image, and/or associated audio if any, transmitted with means comprising data packets, by means of an online, computer, phone, and/or hybrid network, with elements comprising,
text, hyperlink, graphics, other audio, other image, and/or other performing element comprising a program, application, service, platform, and/or a combination thereof.

5. An enhanced and/or new system, process, procedure, product, and/or product-by-process, of, and/or for, a NIC of claim 1, 2, 3, or 4: for recording, a visual and/or audio-visual performance displaying during communication (“PDDC”) of “image content” comprising associated audio if any, transmitted with means comprising data packets, by means of an online, computer, phone, and/or hybrid network.

6. An enhanced and/or new system, process, procedure, product, product-by-process, and/or service, of, and/or for, a NIC of claim 2 or 3: a wireless handheld computer device, apparatus, machine, article of manufacture, program, application, service, platform, service software, software service, and/or a combination thereof; for performance displaying during communication of ‘moving picture’, image, and/or associated audio if any, transmitted with means comprising data packets, by means comprising a network. C. Specification claim—“Prior Application Specification A”: End C. Specification claim—“Prior Application Specification”: Begin

7. An enhanced and/or new system, process, procedure, product, product-by-process, and/or service, of, and/or for, a NIC of claim 2 or 3: a wireline phone, wireless handheld, and/or mobile phone device, apparatus, machine, article of manufacture, program, application, service, platform, service software, software service, and/or a combination thereof; for performance displaying during communication of ‘moving picture’, image, and/or associated audio if any, transmitted with means comprising data packets, by means comprising a network. C. Specification claim—“Prior Application Specification”: End C. Specification claim—“Prior Application Specification A”: Begin

8. An enhanced and/or new system, process, procedure, product, and/or product-by-process, of, and/or for, a NIC of claim 2, 3, or 4: a Converged Platform with means of a user-account and/or an internet user-account (“IUA”) login, comprising a service software, software service, platform, and/or a combination thereof, means with a:
(1) DI Platform for converged communication, with means of a user-account consisting more than one communication program, application, service, platform, service software, software service, and/or a combination thereof; and/or
(2) CD Platform for converged communication and web presenting, with means of, a communication, and a web presenting, program, application, service, platform, service software, software service, and/or a combination thereof; said web presenting, comprising with means of a web template, comprising “image content” and/or IM_COMB;
where a said Converged Platform comprises for communication from and/or to said user-account holder; or a said communication from and/or to, and a said web presenting to, a host, another user-account holder, and/or the public; for performance displaying during communication comprising “image content” and/or IM_COMB, transmitted with means comprising data packets, by means of a network, with elements comprising a combination of,
text, hyperlink, graphics, audio, image, ‘moving picture’, and/or other performance element comprising a program, application, service, platform, and/or a combination thereof.

9. An enhanced and/or new system, process, procedure, product, and/or product-by-process, of, and/or for, a NIC of claim 8, with means of a user-account and/or an internet user-account (“IUA”) login: namely an enhanced DI Platform and/or CD Platform, comprising additional features for inputting, fusing, integrating, and/or porting, of an:
(1) external communication program, application, service, platform, service software, software service, and/or a combination thereof, into and/or off-from said enhanced DI Platform; and/or
(2) external communication program, application, service, platform, service software, software service, a combination thereof; and/or an external web presenting program, application, service, platform, service software, software service, an element, content, and/or a combination thereof; into and/or off-from said enhanced CD Platform;
comprising selecting, placing, manipulating, arranging, dragging-n-dropping, deleting, enlarging, and/or minimizing for self-use, web presenting, and/or web browsing; for performance displaying during communication comprising “image content” and/or IM_COMB, transmitted with means comprising data packets, by means of a network, with elements comprising a combination of,
text, hyperlink, graphics, audio, image, ‘moving picture’, and/or other performance element comprising a program, application, service, platform, and/or a combination thereof.

10. An enhanced and/or new system, process, procedure, product, and/or product-by-process, of, and/or for, a NIC of claim 2, 3, or 4: a Converged Platform with means of a user-account and/or an internet user-account (“IUA”), comprising a service software, software service, platform, and/or a combination thereof, for creating, modifying, and/or presenting to another, means with a:
(1) WP Platform for converged web presenting, with means of a web presenting program, application, service, platform, service software, software service, and/or a combination thereof, comprising with means of a web template, comprising “image content” and/or IM_COMB; and/or
(2) CP Platform for converged web presenting and communication, with means of, a web presenting program, application, service, platform, service software, software service, and/or a combination thereof, comprising with means of a web template, comprising “image content” and/or IM_COMB, and a communication program, application, service, platform, service software, software service, and/or a combination thereof, for “image content”, IM_COMB, and/or a real-time comprising asynchronous communication of IM_COMB, with the web presenter;
where a said Converged Platform for web presenting to a host, another user-account holder, and/or the public; or a said web presenting, and communication to and/or from the web presenter; for performance displaying during communication comprising “image content” and/or IM_COMB, transmitted with means comprising data packets, by means of a network, with elements comprising a combination of,
text, hyperlink, graphics, audio, image, ‘moving picture’, and/or other performance element comprising a program, application, service, platform, and/or a combination thereof.

11. An enhanced and/or new system, process, procedure, product, and/or product-by-process, of, and/or for, a NIC of claim 10, with means of a user-account and/or an internet user-account (“IUA”): namely an enhanced WP Platform and/or CP Platform, comprising additional features for inputting, fusing, integrating, and/or porting, of an:
(1) external web presenting program, application, service, platform, service software, software service, an element, content, and/or a combination thereof, into and/or off-from said enhanced WP Platform; and/or
(2) external web presenting program, application, service, platform, service software, software service, an element, content, and/or a combination thereof; and/or an external communication program, application, service, platform, service software, software service, and/or a combination thereof, for “image content”, IM_COMB, and/or a real-time comprising asynchronous communication of IM_COMB with the web presenter; into and/or off-from said enhanced CP Platform;
comprising selecting, placing, manipulating, arranging, deleting, dragging-n-dropping, enlarging, and/or minimizing for web presenting, a said web presenting and communication, and/or web browsing; where a said enhanced Converged Platform for a web presenting to a host, another user-account holder, and/or the public; for performance displaying during communication comprising “image content” and/or IM_COMB, transmitted with means comprising data packets, by means of a network, with elements comprising a combination of,
text, hyperlink, graphics, audio, image, ‘moving picture’, and/or other performance element comprising a program, application, service, platform, and/or a combination thereof.

12. An enhanced and/or new system, process, procedure, product, and/or product-by-process, of, and/or for, a NIC of claim 2, 3, or 4: a service software and/or software service for a web presenting, with means comprising a user-account and/or an internet user-account (“IUA”); means comprising a web template with “image content” and/or IM_COMB; for a said web presenter inputting and/or selecting of a static and/or dynamic privilege, comprising a custom privilege, for accessing, using, and/or browsing, of a said web presenting, an element and/or content thereof, for, and/or during, a web presenting to a host, another user-account holder, and/or the public, with means comprising a website, webpage, and/or PI Platform; with a resultant performance displaying during communication of “image content” and/or IM_COMB comprising a secret, confidential, private, semi-private, group, semi-public, on-demand, public, and/or like privilege, transmitted with means comprising data packets, by means of a network.

13. An enhanced and/or new system, process, procedure, product, and/or product-by-process, of, and/or for, a NIC of claim 2, 3, or 4: a service software and/or software service for a web presenting, with means comprising a user-account and/or an internet user-account (“IUA”); means comprising a web template with “image content” and/or IM_COMB; for a said web presenter inputting and/or selecting of a static and/or dynamic privilege, comprising a custom privilege, for accessing, using, and/or browsing, of a said web presenting, an element and/or content thereof, for, and/or during, a web presenting to a host, another user-account holder, and/or the public, with means comprising a website, webpage, and/or PI Platform, means comprising an adaptable and/or adaptive web template; additionally comprising for granting and/or denying of a request for privilege, by the said another seeking access, using, and/or browsing of a said restricted web presenting, an element and/or content thereof, comprising for, and/or during, presenting a said, to a said another, with means comprising a website, webpage, and/or PI Platform; comprising a:
(1) ‘moving picture’, associated audio if any, and/or a segment thereof;
(2) communication service software, software service, an element, content, and/or a combination thereof;
(3) text, a portion, series, multiples, and/or a collection thereof;
(4) hyperlink, a series, multiples, and/or a collection thereof;
(5) graphics, a portion, series, multiples, and/or a collection thereof;
(6) audio and/or voice, a portion, series, multiples, and/or a collection thereof;
(7) image, a portion, series, multiples, and/or a collection thereof;
(8) ‘moving picture’, a portion, series, multiples, and/or a collection thereof; and/or
(9) IM_COMB, a portion, series, multiples, and/or a collection thereof;
on a said web presenting, for performance displaying during communication of “image content” and/or IM_COMB, transmitted with means comprising data packets, by means of a network.

14. An enhanced and/or new system, process, procedure, product, and/or product-by-process, of, and/or for, a NIC of claim 2, 3, or 4: a service software and/or software service of, and/or for, a web presenting, with means comprising a user-account and/or an internet user-account (“IUA”), for enabling and/or presenting of dynamics and/or motion of, and/or for, an “image content” and/or IM_COMB; comprising with means of a CD Platform, WP Platform, CP Platform, and/or an enhancement thereof; a said comprising for inputting, fusing, and/or integrating of “image content” and/or IM_COMB, and comprising enabling of dynamics and/or motion; for a web presenting to a host, another user-account holder, and/or the public, with means comprising a website, webpage, and/or PI Platform, for performance displaying during communication of a said dynamics and/or motion of “image content” and/or IM_COMB, transmitted with means comprising data packets, by means of a network.

15. An enhanced and/or new system, process, procedure, product, and/or product-by-process, of, and/or for, a NIC of claim 2, 3, or 4: a service software and/or software service for a web presenting, with means comprising a user-account and/or an internet user-account (“IUA”), for enabling and/or presenting a said user-account holder, for an input and/or selecting of, a:
(1) dynamics and/or motion for bringing an “image content” and/or IM_COMB up for displaying,
(2) dynamics and/or motion for moving an “image content” and/or IM_COMB on display,
(3) dynamics and/or motion for taking an “image content” and/or IM_COMB off-from displaying, and/or
(4) time interval and/or interval time, for dynamics and/or motion of “image content” and/or IM_COMB,
for performance displaying during communication of “image content” and/or IM_COMB, transmitted with means comprising data packets, by means of a network. C. Specification claim—“Prior Application Specification A”: End C. Specification claim—“Prior Application Specification”: Begin

16. An enhanced and/or new system, process, procedure, product, and/or product-by-process, of, and/or for, comprising a NIC of claim 1: a portable and/or mobile; standalone, system- and/or device-integrated; visual and/or audio-visual; multi-terminal electronic display device, apparatus, or machine, for performance displaying during communication of “image content” and/or IM_COMB, transmitted with means comprising data packets, by means comprising a network. C. Specification claim—“Prior Application Specification”: End C.I.P. Specification claim—“Prior Application Specification B”: Begin

17. An enhanced and/or new system, process, procedure, product, and/or product-by-process, of, and/or for, comprising a NIC of claim 1: a real-time network translating of “image content” and/or IM_COMB, by means of a computer, phone, and/or hybrid network, (1) where the forward translator resides in a remote Native language, or English language, server, host, user-client, client-user, and/or desktop platform, for translating during network communication respectively from, a source English language to a Native language, or a source Native language to the English language; (2) vice versa, where the reverse translator resides in a remote Native language or English language server, host, user-client, client-user, and/or desktop platform, for translating during network communication respectively from, a source Native language to the English language, or a source English language to a Native language; (3) where the forward, and reverse, translators reside in a local English language server, host, user-client, client-user, and/or desktop platform, for translating respectively from, a source English language to a Native language, or a source Native language to the English language, during network communication; (4) vice versa, where the forward, and reverse, translators reside in a local Native language server, host, user-client, client-user, and/or desktop platform, for translating respectively from, a source Native language to the English language, or a source English language to a Native language, during network communication; and/or (5) network communication of an asynchronous, real-time network translated “image content” and/or IM_COMB; for performance displaying during communication of a real-time network translated “image content” and/or IM_COMB, transmitted with means comprising data packets, by means of a network; and/or a real-time and/or asynchronous translating of “image content” and/or IM_COMB, with means of a translator in a user-client, client-user, and/or desktop platform, for performance displaying during communication of translated “image content” and/or IM_COMB by means comprising a network.

18. An enhanced and/or new system, process, procedure, product, and/or product-by-process, of, and/or for, comprising a NIC of claim 1: wherein the translating is from language 1 to language 2, limiting further where neither of said language is English, the system, process, procedure, product, and/or product-by-process, comprising of translating language 1 to the English and/or another language, and thereof translating the said translated to language, to language 2, with means of said translators comprising in canonical sequence, in a local or remote server, host, user-client, client-user, and/or desktop platform, for performance displaying during communication of translated “image content” and/or IM_COMB, transmitted with means comprising data packets, by means comprising a network. C.I.P. Specification claim “Prior Application Specification B”: End C. Specification claim—“Prior Application Specification”: Begin

19. An enhanced and/or new system, process, procedure, product, and/or product-by-process, of, and/or for, a NIC of claim 1 thru 18: for performance displaying during communication of “image content” and associated audio if any, transmitted with means of a combined “image content” data packet, consisting said “image content” image and audio data, by means of a network. ====C. Specification claim—“Prior Application Specification”: End C. Specification claim—“Prior Application Specification”: Begin

20. An enhanced and/or new system, process, procedure, product, and/or product-by-process, of, and/or for, a NIC of claim 1 thru 19: for performance displaying during communication (“PDDC”) of “image content” and associated audio if any, and/or IM_COMB, transmitted with means comprising data packets, consisting with means of a user initiated dedicated communication channel-link (“UIDCL”) for a said PDDC session, by means of a network. C. Specification claim—“Prior Application Specification”: End
